(19) United States
(12) Patent Application Publication
(10) Pub. No.: US 2015/0088292 A1
(43) Pub. Date: Mar. 26, 2015

(54) METHOD OF PROVIDING DATA FOR MINIMIZING DIFFERENCE BETWEEN DIMENSIONS OF THREE-DIMENSIONAL STRUCTURE FORMED BY LASER RADIATION AND DESIGN VALUES OF SCAN PATH OF SUCH THREE-DIMENSIONAL STRUCTURE AND COMPUTER AND COMPUTER PROGRAM FOR PROVIDING SUCH DATA

(71) Applicant: INTERNATIONAL BUSINESS MACHINES CORPORATION, Armonk, NY (US)

(72) Inventors: Tadanobu Inoue, Kanagawa (JP); Yasunao Katayama, Tokyo (JP); Masaharu Sakamoto, Kanagawa (JP)

(21) Appl. No.: 14/490,713

(22) Filed: Sep. 19, 2014

(30) Foreign Application Priority Data
Sep. 20, 2013 (JP) 2013-195370

(51) Int. Cl. G06F 17/50; B22F 3/00; B28B 17/00; B29C 67/00; B28B 1/00

(52) U.S. Cl. CPC G06F 17/50; B29C 67/0088; B29C 67/0077; B28B 1/001; B28B 17/0081; B22F 3/008; B29K 2105/251
USPC 700/98; 425/140; 425/78

(57) ABSTRACT

Acquiring expected precision even in a case that partial shrinkage occurs. The present invention is a technique for providing data for minimizing a difference between dimensions of a three-dimensional structure formed by laser radiation and design values of a scan path of the three-dimensional structure, in which the technique includes: modeling a manufacturing process of the three-dimensional structure and formulating a shrinkage of material used in the manufacturing process; and performing an optimization calculation for minimizing the difference between the dimensions of the three-dimensional structure after the shrinkage of the material and the design values by using the formulated shrinkage model to compute the scan length x minimizing the difference, and in which the formulation includes formulating a shrinkage function in the case where the material shrinks according to the scan length xᵢ of the scan path of the laser.

### CROSS-REFERENCE TO RELATED APPLICATION

This application claims priority under 35 U.S.C. §119 from Japanese Patent Application No. 2013-195370 filed Sep. 20, 2013, the entire contents of which are incorporated herein by reference.

### BACKGROUND OF THE INVENTION

The present invention relates to a technique for providing data for minimizing a difference between the dimensions of a three-dimensional structure formed by laser radiation and the design values of a scan path of the three-dimensional structure.

### BACKGROUND ART

An additive manufacturing (AM) technology was introduced to the world about 20 years ago. At that time, it attracted attention as a revolutionary technology capable of rapidly manufacturing a resin product model by way of trial without making a mold. Therefore, it has been also referred to as “rapid prototyping.”

The additive manufacturing technology is capable of directly manufacturing a three-dimensional structure from three-dimensional CAD data and therefore is expected as a technology for flexibly creating a product (for example, manufacturing a final product such as a single item or a small-quantity product) so as to suit diversifying customer tastes without making a mold. In addition, the additive manufacturing technology is useful as a technique for promptly creating only a shape along with a decrease in product development cycle time. In recent years, a low-cost device which is called “3D printer” has become commercially available and thus awareness of the additive manufacturing technology is rapidly increasing.

In the additive manufacturing technology, a technique called “layered manufacturing method” is used. In the layered manufacturing method, a three-dimensional CAD data is sliced to provide slice data (cross-sectional data) and then the slice data is superimposed on each other and is provided as original data for manufacturing.

Layered manufacturing methods, such as stereolithography, powder sintering shaping (also referred to as “selective laser sintering”), fused deposition modeling, sheet lamination, and ink-jet methods, have already been known.

The aforementioned stereolithography is a method of manufacturing an arbitrary three-dimensional structure by irradiating a photo-curable liquid with a laser beam to cure the photo-curable liquid in order to form cured layers each having a given thickness and stacking the cured layers. For an example of stereolithography, refer to Japanese Patent Application Publication No. 2001-315214 described below.

The aforementioned selective laser sintering method is a method of manufacturing an arbitrary three-dimensional structure by sequentially fusing metal or resin powder by using a laser heat source and sintering the metal or resin powder and then stacking the sintered layers. For an example of the selective laser sintering method, refer to Japanese Patent Application Publication No. Hei 7-125078 and Japanese Patent Application Publication No. Hei 7-276506 described below).

Japanese Patent Application Publication No. 2001-315214 describes a stereolithography method of manufacturing a three-dimensional object by irradiating a photo-curable resin of liquid with light, wherein a curing depth, which is a depth dimension of curing corrected by illuminance, and a curing width, which is a width dimension on a shaping surface corrected by illuminance, are obtained as curing parameters of the photo-curable resin; and the accuracy of dimensions of the three-dimensional object is estimated on the basis of the curing depth and the curing width to perform optical shaping (Claim 1).

Japanese Patent Application Publication No. Hei 7-125078 and Japanese Patent Application Publication No. Hei 7-276506 describe methods of automatically detecting the bottom surface of a shaped object and the bottom surface of an overhanging portion and automatically correcting essential dimensional deviation in a stereolithography technique (paragraph 0009) in order to solve a problem (dimensional deviation) of excess curing due to cumulative leaked light of a laser beam having passed through the cured material during stacking on the bottom surface of a horizontal plate or the bottom surface of an overhanging portion in the stereolithography technique (paragraph 0005).

Japanese Patent Application Publication No. 2000-211033 describes that a shaped object is formed by radiating light and thereafter curing promotion energy is imparted to the shaped object with the deformation of the shaped object constrained (paragraph 0004, claim 1) in order to solve a problem that the shaped object easily deforms when uncured liquid is cured in the case of imparting the curing promotion energy (heating) in order to curing the uncured liquid in the shaped object formed by stereolithography (paragraph 0003).

Japanese Patent Application Publication No. 2005-81563 describes that a limitation is imposed on the viscosity of support material for a three-dimensional object made by layered manufacturing (paragraph 0021) in an ink-jet type layered manufacturing apparatus (paragraph 0018).

Japanese Patent Application Publication No. 2004-90530 describes that a multi-head unit, which is provided with a plurality of head units having a plurality of heads with a plurality of nozzles having a jetting width of at least the length of one side of the shaping range, is moved in an axial direction (claim 1) in an ink-jet type additive manufacturing apparatus (paragraph 0001).

Japanese Patent Application Publication No. Hei 10-100263 describes that there is provided a three-dimensional object shaping method of manufacturing a three-dimensional object which can be precisely observed by using high speed photography or the like even in the case of a heat-resistant optical shaped article (paragraph 0014).

Japanese Patent Application Publication No. Hei 10-29245 describes a shaping apparatus and method capable of generating a three-dimensional shaped object or a shape thereof based on the attribute data of three-dimensional-space elements which specify the three-dimensional shaped object (paragraph 0004).

Japanese Translation of PCT International Application Publication No. 2003-508828 describes a method of generating instructions for creating an expression of a computer aided design model for an output device which has at least one nozzle (claim 1).

“Theoretical Analysis and Experimental Evaluation on Solidified parts' Surplus Growth in Stereo-lithography” by Akiya Kamimura et al. describes that an exposed surface is raster-scanned with a constant exposure amount and constant hatch spacing by using a laser, a theoretical analysis is performed with respect to surplus growth on the bottom surface of cured material in repeating curing and lamination, and a theoretical approximate expression is calculated to predict the maximum thickness of the surplus growth compatible with various parameters (page 1053, right column, lines 6 to 10).

“Rapid Prototyping System Using Selective Laser Sintering” by Masayuki Hachisuka et al. describes a forming shrinkage and a natural correction in a selective laser sintering method (FIG. 5).

“Recent Development Trend of Laser Layered Manufacturing Technology” by Hideki Kyogoku describes that high-precision processing technology using resin powder becomes achievable, though not using metal material, with respect to the precision of a laser layered manufacturing article and that this enables the minimum wall thickness 0.2 mm by decreasing the laser beam diameter by using a fiber laser, limiting the nylon powder particle size to 20 μm or so, and adding laser absorbent according to the Beer-Lambert law (page 71, lines 3 to 6).

Accuracy of dimension is a technical problem in the additive manufacturing technology.

### SUMMARY OF THE INVENTION

Accordingly, one aspect of the present invention is a computer implemented method for providing data for minimizing a difference between a plurality of dimensions of a three-dimensional structure formed by a laser radiation and a plurality of design values of a scan path of the three-dimensional structure, the method including: modeling a manufacturing process of the three-dimensional structure and formulating a shrinkage of material used in the manufacturing process, in which a shrinkage function is formulated in the case where the material shrinks depending on a scan length xᵢ of the scan path of the laser and in which the shrinkage function is represented by an Equation 1; and performing an optimization calculation for minimizing a difference between the dimensions of the three-dimensional structure after the shrinkage of the material and the design values by using the shrinkage model formulated according to the Equation 1 and computing a scan length x minimizing the difference; in which xᵢ of the Equation 1 is the scan length of the scan path and s(l) of the Equation 1 is a shrinkage rate per unit length of the material.

Accordingly, another aspect of the present invention is a computer implemented method of providing data for minimizing a difference between a plurality of dimensions of a three-dimensional structure formed by a laser radiation and a plurality of design values of a scan path of the three-dimensional structure, the method including: receiving a three-dimensional model data; providing a slice data from the three-dimensional model data; providing a scan path data from the slice data; modeling a manufacturing process of the three-dimensional structure and formulating a shrinkage of material used in the manufacturing process, in which a shrinkage function is formulated in the case where the material shrinks depending on a scan length xᵢ of the scan path of the laser and in which the shrinkage function is represented by an Equation 1; performing an optimization calculation for minimizing a difference between the dimensions of the three-dimensional structure after the shrinkage of the material and the design values by using the shrinkage model formulated according to the Equation 1 and computing a scan length x minimizing the difference; and outputting the scan path data including a scan length x minimizing the difference; in which xᵢ of the Equation 1 is the scan length of the scan path and s(l) of the Equation 1 is a shrinkage rate per unit length of the material.

Accordingly, another aspect of the present invention is a non-transitory computer program product for providing data for minimizing a difference between a plurality of dimensions of a three-dimensional structure formed by a laser radiation and a plurality of design values of a scan path of the three-dimensional structure, the computer program product including a computer readable storage medium having program instructions embodied therewith which, when executed, cause a computer device to perform the steps of a method including: modeling a manufacturing process of the three-dimensional structure and formulating a shrinkage of material used in the manufacturing process, in which a shrinkage function is formulated in the case where the material shrinks depending on a scan length xᵢ of the scan path of the laser and in which the shrinkage function is represented by an Equation 1; and performing an optimization calculation for minimizing a difference between the dimensions of the three-dimensional structure after the shrinkage of the material and the design values by using the shrinkage model formulated according to the Equation 1 and computing a scan length x minimizing the difference; in which xᵢ of the Equation 1 is the scan length of the scan path and s(l) of the Equation 1 is a shrinkage rate per unit length of the material.

Accordingly, another aspect of the present invention is a three-dimensional structure manufacturing machine which is connected to a computer having a storage medium storing the non-transitory computer program product including a computer readable storage medium having program instructions embodied therewith which, when executed, cause a computer device to perform the steps of a method including: modeling a manufacturing process of the three-dimensional structure and formulating a shrinkage of material used in the manufacturing process, in which a shrinkage function is formulated in the case where the material shrinks depending on a scan length xᵢ of the scan path of the laser and in which the shrinkage function is represented by an Equation 1; and performing an optimization calculation for minimizing a difference between the dimensions of the three-dimensional structure after the shrinkage of the material and the design values by using the shrinkage model formulated according to the Equation 1 and computing a scan length x minimizing the difference; in which xᵢ of the Equation 1 is the scan length of the scan path and s(l) of the Equation 1 is a shrinkage rate per unit length of the material.

### BRIEF DESCRIPTION OF THE DRAWINGS

FIG. 1 is a diagram illustrating an example of a computer which can be used in an embodiment of the present invention.

FIG. 2 is a block diagram for providing scan path data for minimizing a difference between the dimensions of a three-dimensional structure formed by laser radiation and the design values of a scan path of a three-dimensional structure (hereinafter, also referred to as optimized scan path data), slice data optimized based on the optimized scan path data, and three-dimensional model data optimized based on the optimized slice data according to an embodiment of the present invention.

FIG. 3 is a flowchart for providing the aforementioned optimized scan path data, the aforementioned optimized slice data, and the aforementioned optimized three-dimensional model data according to the block diagram illustrated in FIG. 2.

FIG. 4 is a block diagram for modeling the manufacturing process of the three-dimensional structure and formulating the shrinkage of a material for use in the manufacturing process according to an embodiment of the present invention.

FIG. 5A is a block diagram for modeling the manufacturing process of the three-dimensional structure and formulating the shrinkage of the material for use in the manufacturing process according to an embodiment of the present invention.

FIG. 5B is a block diagram for modeling the manufacturing process of the three-dimensional structure and formulating the shrinkage of the material for use in the manufacturing process according to an embodiment of the present invention.

FIG. 6A is a block diagram for modeling the manufacturing process of the three-dimensional structure and formulating the shrinkage of the material for use in the manufacturing process according to an embodiment of the present invention.

FIG. 6B is a block diagram for modeling the manufacturing process of the three-dimensional structure and formulating the shrinkage of the material for use in the manufacturing process according to an embodiment of the present invention.

FIG. 7A is a block diagram for modeling the manufacturing process of the three-dimensional structure and formulating the shrinkage of the material for use in the manufacturing process according to an embodiment of the present invention.

FIG. 7B is a block diagram for modeling the manufacturing process of the three-dimensional structure and formulating the shrinkage of the material for use in the manufacturing process according to an embodiment of the present invention.

FIG. 8A is a block diagram for modeling the manufacturing process of the three-dimensional structure and formulating the shrinkage of the material for use in the manufacturing process according to an embodiment of the present invention.

FIG. 8B is a block diagram for modeling the manufacturing process of the three-dimensional structure and formulating the shrinkage of the material for use in the manufacturing process according to an embodiment of the present invention.

FIG. 9 is a diagram illustrating two examples of a block diagram for formulating the shrinkage in response to a break of the material caused by the shrinkage of the material when the scan path is irradiated with laser according to an embodiment of the present invention. More specifically:

Example A illustrates that the shrinkage is formulated as a shrinkage function with a constraint condition of a length in response to the break of the material caused by the shrinkage of the material when the scan path is irradiated with laser; and

Example B illustrates that the scan path is divided into a plurality of paths in response to a break of the material caused by the shrinkage of the material when the scan path is irradiated with laser and then the shrinkage for each divided path is formulated as a shrinkage function.

FIG. 10 is diagrams illustrating the Beer-Lambert law and a laser beam scanning model for describing that the optimization calculation is performed conforming to a constraint condition of the thickness of a surplus growth according to an embodiment of the present invention. More specifically:

Diagram A illustrates the penetration depth Dₚ means a depth at which the exposure amount reaches 1/e of the irradiance level on the exposed surface; and

Diagram B illustrates the exposure amount distribution for a single curing line is calculated according to Equation 15 on the yz cross section in the position of a certain x, assuming that the laser scanning direction is the x-axis positive direction, the depth direction is the z-axis positive direction, and the exposed surface exists at the z origin.

FIG. 11 is steps illustrating a three-dimensional structure manufactured using a conventional technique and a three-dimensional structure manufactured according to an embodiment of the present invention. More specifically:

Step A (illustrated only in the X-Y plane) (1101) is a shape into which the three-dimensional structure is intended to be manufactured;

Step B represents a design value of an expected scan path, which has been provided from STL data for manufacturing the shape A according to the conventional art;

Step C represents a shape of the three-dimensional structure (the shape only in the X-Y plane is illustrated) which has been manufactured by using a three-dimensional structure manufacturing machine based on the design value of the scan path;

Step D represents a design value of a scan path provided by performing an optimization calculation for minimizing a difference between the dimensions of the three-dimensional structure after the shrinkage of the material and the design values by using a shrinkage model formulated according to an embodiment of the present invention and computing the scan length minimizing the difference; and

Step E represents a shape of the three-dimensional structure (the shape only in the X-Y plane is illustrated) which has been manufactured by using a three-dimensional structure manufacturing machine based on the design value of the scan path provided according to an embodiment of the present invention.

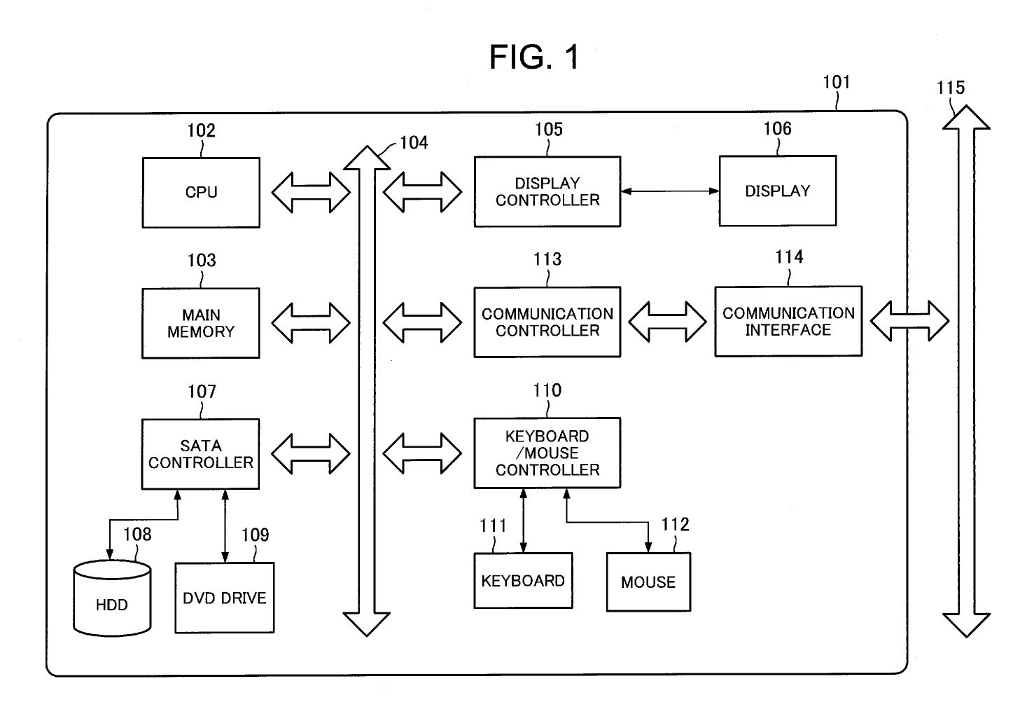

FIG. 12 is a diagram illustrating an example of a functional block diagram of a computer preferably having a hardware configuration illustrated in FIG. 1 and according to an embodiment of the present invention.

FIG. 13 is a diagram illustrating a practical example and a comparative example according to an embodiment of the present invention. More specifically:

Diagram A illustrates a three-dimensional shape which is a manufacturing target;

Diagram B illustrates a three-dimensional shape with the design shape changed in anticipation of a shrinkage of the material according to the conventional technique; and

Diagram C illustrates a three-dimensional shape with the design shape changed by performing an optimization calculation for minimizing a difference between the dimensions of the three-dimensional structure after the shrinkage of the material and the design values by using the formulated shrinkage model and computing a scan length x which minimizes the difference according to an embodiment of the present invention.

FIG. 14 is a diagram illustrating normalized manufacturing errors of three-dimensional structures in the case of the three-dimensional shape as the manufacturing target of FIG. 13 with: (1) no change in the design shape; (2) the design shape changed according to the conventional technique as illustrated in FIG. 13 Diagram B; and (3) the design shape changed according to an embodiment of the present invention as illustrated in FIG. 13 Diagram C.

### DETAILED DESCRIPTION OF THE PREFERRED EMBODIMENT

### Technical Problems

The accuracy of dimensions is a problem in the additive manufacturing technology field.

In the stereolithography, liquid photo-curable resin is irradiated with laser and cured one layer by one layer to form a three-dimensional structure. In performing the photo-curing, however, shrinkage of the aforementioned photo-curable resin, particularly partial shrinkage, occurs. Therefore, it is difficult to acquire an expected precision.

In the powder sintering shaping method, an arbitrary three-dimensional cross-sectional shape is scanned and irradiated with laser to sequentially fuse and sinter the resin, metal powder, and the like by using a heat source of the laser for lamination in order to form a three-dimensional structure. At the time of the laser radiation, the instantly-fused powder material inevitably settles down. Therefore, at the time of sintering, most of the shrinkage is naturally corrected by an excess curing unit in the z-axis direction (Refer to Rapid Prototyping System Using Selective Laser Sintering” by Masayuki Hachisuka et al.). A linear shrinkage caused by heat, however, still exists. Therefore, it is difficult to acquire expected precision.

In order to solve the above problem of the shrinkage in the stereolithography, as a conventional technique, there has been used a technique for reducing the shrinkage rate of photo-curable resin by devising an appropriate mixture fraction of an acrylic resin and an epoxy resin or an appropriate type of the resin. In the conventional technique, however, the strength or heat resistance of the three-dimensional structure is sacrificed, instead of reducing the shrinkage rate. Furthermore, as another conventional technique, simple correction is performed by irradiating the three-dimensional structure with laser in a little larger range in whole based on a shrinkage rate. Depending on the shape of a desired three-dimensional structure, however, partial shrinkage occurs. Therefore, there are some cases which cannot be resolved by the simple correction with laser radiation in a little larger range in whole.

Therefore, it is an object of the present invention to provide a technique for acquiring expected precision even in a case that a partial shrinkage occurs, instead of the simple correction with laser radiation in a little larger range in whole based on a shrinkage rate.

### Solution to Problems

The present invention provides a technique for providing data for minimizing a difference between the dimensions of a three-dimensional structure formed by laser radiation and the design values of a scan path of the three-dimensional structure.

The aforementioned technique can include a method and a computer, a computer program, and a computer program product for executing the method.

Moreover, the present invention provides a three-dimensional structure manufacturing machine connected to the aforementioned computer or having the computer.

Furthermore, the present invention provides a three-dimensional structure manufacturing machine which is connected to a computer having a storage medium storing the computer program or which includes a computer having a storage medium storing the computer program.

According to a first aspect of the present invention, there is provided a method of providing data for minimizing a difference between dimensions of a three-dimensional structure formed by laser radiation and design values of a scan path of the three-dimensional structure, the method including the steps of:

modeling the manufacturing process of the three-dimensional structure and formulating a shrinkage of material used in the manufacturing process, in which a shrinkage function is formulated in the case where the material shrinks depending on a scan length xᵢ of the scan path of the laser and in which the shrinkage function is represented by the following Equation 1:

ƒ(xᵢ)=∫₀^{x}^{ᵢ}s(l)dl [Equation. 1]

where: xᵢ is the scan length of the scan path; and s(l) is a shrinkage rate per unit length of the material;

and performing an optimization calculation for minimizing a difference between the dimensions of the three-dimensional structure after the shrinkage of the material and the design values by using the shrinkage model formulated according to the Equation 1 and computing a scan length x minimizing the difference.

According to a second aspect of the present invention, there is provided a method of providing data for minimizing a difference between dimensions of a three-dimensional structure formed by laser radiation and design values of a scan path of the three-dimensional structure, the method including the steps of:

receiving three-dimensional model data; providing slice data from the three-dimensional model data;

providing scan path data from the slice data;

modeling a manufacturing process of the three-dimensional structure and formulating a shrinkage of material used in the manufacturing process, including the step of formulating a shrinkage function in the case where the material shrinks depending on a scan length xᵢ of the scan path of the laser in the scan path data, wherein the shrinkage function is represented by the above Equation 1:

performing an optimization calculation for minimizing a difference between the dimensions of the three-dimensional structure after the shrinkage of the material and the design values by using the formulated shrinkage model and computing a scan length x minimizing the difference; and

outputting scan path data including the scan length x minimizing the difference.

In one embodiment of the present invention, the method according to the second aspect of the invention can further include the steps of:

providing optimized slice data from the scan path data including the output scan length x; and

providing optimized three-dimensional model data from the optimized slice data.

According to a third aspect of the present invention, there is provided a computer which provides data for minimizing a difference between dimensions of a three-dimensional structure formed by laser radiation and design values of a scan path of the three-dimensional structure, the computer including:

formulation means for modeling a manufacturing process of the three-dimensional structure and formulating a shrinkage of material used in the manufacturing process, in which a shrinkage function is formulated in the case where the material shrinks depending on a scan length xᵢ of the scan path of the laser and in which the shrinkage function is represented by the above Equation 1; and

optimization calculation means for performing an optimization calculation for minimizing a difference between the dimensions of the three-dimensional structure after the shrinkage of the material and the design values by using the shrinkage model formulated according to the Equation 1 and computing a scan length minimizing the difference.

According to a fourth aspect of the present invention, there is provided a computer which provides data for minimizing a difference between dimensions of a three-dimensional structure formed by laser radiation and design values of a scan path of the three-dimensional structure, the computer including:

three-dimensional model data accepting means for accepting three-dimensional model data; first slice data providing means for providing slice data from the three-dimensional model data; scan path data providing means for providing scan path data from the slice data;

formulation means for modeling a manufacturing process of the three-dimensional structure and formulating a shrinkage of material used in the manufacturing process, in which a shrinkage function is formulated in the case where the material shrinks depending on a scan length x of the scan path of the laser and in which the shrinkage function is represented by the above Equation 1;

optimization calculation means for performing an optimization calculation for minimizing a difference between the dimensions of the three-dimensional structure after the shrinkage of the material and the design values by using the shrinkage model formulated according to the Equation 1 and computing a scan length minimizing the difference; and

scan path data output means for outputting scan path data including the scan length x minimizing the difference.

In one embodiment of the present invention, the computer according to the fourth aspect of the invention can further include:

second slice data providing means for providing optimized slice data from the output scan path data including the scan length x; and

three-dimensional model data providing means for providing optimized three-dimensional model data from the optimized slice data.

In one embodiment of the present invention, the formulation means can formulate a shrinkage function ƒ(x, p) represented by the following Equation 2:

ƒ(xᵢ,p)=∫₀^{s}^{ᵢ}s(l,p)dl [Equation. 2]

where: xᵢ is the scan length of the scan path; s(l, p) is a shrinkage rate per unit length of the material; and p is a shaping parameter of the manufacturing process.

In one embodiment of the present invention, the formulation means can formulate a shrinkage function ƒ(xᵢ, xⱼ) represented by the following Equation 3:

ƒ(xᵢ,xᵢ)=∫₀^{xi}s(l,xⱼ)dl [Equation. 3]

where: xᵢ is the scan length of the scan path; s(l, xⱼ) is a shrinkage rate per unit length of the material; and xⱼ is a length of a shaped object of a scan path adjacent to the scan path scanned across the scan length xᵢ.

In one embodiment of the present invention, the formulation means can formulate a shrinkage function ƒ(xᵢ, xⱼ, p) represented by the following Equation 4:

ƒ(xᵢ,xⱼ,p)=∫₀^{x}^{ᵢ}s(l,xⱼ,p)dl [Equation. 4]

where: xᵢ is the scan length of the scan path; s(l, xⱼ, p) is a shrinkage rate per unit length of the material; xⱼ is a length of a shaped object of a scan path adjacent to the scan path scanned across the scan length xᵢ; and p is a shaping parameter of the manufacturing process.

In one embodiment of the present invention, the formulation means can formulate a shrinkage function ƒ(xᵢ, xⱼ) represented by the following Equation 5:

$$f ( {x}_{i} , {x}_{j} ) = \text{?} s ( l , {x}_{j} ) d l = \text{?} {a}_{1} d l + \text{?} {a}_{2} d l + \text{?} {a}_{3} d l \\ \text{?} \text{indicates text missing or illegible when filed} \qquad [ Equation . 5 ]$$

where: xᵢ is the scan length of the scan path; xⱼₛ is a starting point of a shaped object adjacent to the scan path scanned across the scan length xᵢ; xⱼₑ is an end point of the shaped object adjacent to the scan path scanned across the scan length xᵢ; a₁ is a shrinkage rate per unit length of the scan path having a length from the starting point of the scan path scanned across the scan length xᵢ to the point xⱼₛ; a₂ is a shrinkage rate per unit length of the scan path having a length from the point xⱼₛ to the point xⱼₑ: a₃ is a shrinkage rate per unit length of the scan path having a length from the point xⱼₑ to the point xᵢ: and s(l, xⱼ) is a shrinkage rate per unit length of the material and is represented by the following Equation 6:

$$s ( l , {x}_{j} ) = \{ \begin{matrix}{a}_{1} & ( 0 \leq l < {x}_{js} ) \\ {a}_{2} & ( {x}_{js} \leq l < {x}_{je} ) \\ {a}_{3} & ( {x}_{je} \leq l < {x}_{i )}\end{matrix} \qquad [ Equation . 6 ]$$

In one embodiment of the present invention, the formulation means can formulate a shrinkage function ƒ(xᵢ, xⱼ, p) represented by the following Equation 7:

$$f ( {x}_{i} , {x}_{j} , p ) = \text{?} s ( l , {x}_{j} , p ) d l = \text{?} {a}_{1} ( p ) d l + \text{?} {a}_{2} ( p ) d l + \text{?} {a}_{3} ( p ) d l \\ \text{?} \text{indicates text missing or illegible when filed} \qquad [ Equation . 7 ]$$

where: xᵢ is the scan length of the scan path; xⱼₛ is a starting point of a shaped object adjacent to the scan path scanned across the scan length xᵢ; xⱼₑ is an end point of the shaped object adjacent to the scan path scanned across the scan length xᵢ; p is a shaping parameter of the manufacturing process; a₁ is a shrinkage rate per unit length of the scan path, which fluctuates with the shaping parameter, having a length from the starting point of the scan path scanned across the scan length xᵢ to the point xⱼₛ; a₂ is a shrinkage rate per unit length of the scan path, which fluctuates with the shaping parameter, having a length from the point xⱼₛ to the point xⱼₑ; a₃ is a shrinkage rate per unit length of the scan path, which fluctuates with the shaping parameter, having a length from the point xⱼₑ to the point xᵢ; and s(l, xⱼ, p) is a shrinkage rate per unit length of the material and represented by the following Equation 8:

$$s ( l , {x}_{j} , p ) = \{ \begin{matrix}{a}_{1} ( p ) & ( 0 \leq l < {x}_{js} ) \\ {a}_{2} ( p ) & ( {x}_{js} \leq l < \text{?} ) \\ {a}_{3} ( p ) & ( {x}_{je} \leq l < \text{?} )\end{matrix} \\ \text{?} \text{indicates text missing or illegible when filed} \qquad [ Equation . 8 ]$$

In one embodiment of the present invention, the formulation means can formulate a shrinkage function ƒ(xᵢ, xⱼ, xₖ) is represented by the following Equation 9:

$$f ( {x}_{i} , {x}_{j} , \text{?} ) = \text{?} s ( l , {x}_{j} , \text{?} ) d l = \text{?} {a}_{1} d l + \text{?} {a}_{2} d l + \text{?} {a}_{3} d l + \text{?} {a}_{4} d l + \text{?} {a}_{5} d l \\ \text{?} \text{indicates text missing or illegible when filed} \qquad [ Equation . 9 ]$$

where: xᵢ is the scan length of the scan path; xⱼₛ is a starting point of a first shaped object adjacent to the scan path scanned across the scan length xᵢ; xⱼₑ is an end point of the first shaped object adjacent to the scan path scanned across the scan length xᵢ; xₖₛ is a starting point of a second shaped object adjacent to the scan path scanned across the scan length xᵢ, and the starting point of the second shaped object exists between the starting point of the first shaped object and the end point of the first shaped object; xₖₑ is an end point of the second shaped object adjacent to the scan path scanned across the scan length xᵢ, and the end point of the second shaped object exists between the starting point of the first shaped object and the end point of the first shaped object; a₁ is a shrinkage rate per unit length of the scan path having a length from the starting point of the scan path scanned across the scan length xᵢ to the point xⱼₛ; a₂ is a shrinkage rate per unit length of the scan path having a length from the point xⱼₛ to the point xₖₛ; a₃ is a shrinkage rate per unit length of the scan path having a length from the point xₖₛ to the point xₖₑ; a₄ is a shrinkage rate per unit length of the scan path having a length from the point xₖₑ to the point xⱼₑ; a₅ is a shrinkage rate per unit length of the scan path having a length from the point xⱼₑ to the point xᵢ; and s(l, xⱼ, xₖ) is a shrinkage rate per unit length of the material and represented by the following Equation 10:

$$s ( l , {x}_{j} , {x}_{k} ) = \{ \begin{matrix}{a}_{1} & ( 0 \leq l < \text{?} ) \\ {a}_{2} & ( \text{?} \leq l < \text{?} ) \\ {a}_{3} & ( \text{?} \leq l < \text{?} ) \\ {a}_{4} & ( \text{?} \leq l < {x}_{je} ) \\ {a}_{5} & ( \text{?} \leq l < {x}_{i} )\end{matrix} \\ \text{?} \text{indicates text missing or illegible when filed} \qquad [ Equation . 10 ]$$

In one embodiment of the present invention, the formulation means can formulate a shrinkage function ƒ(xi, xj, xk, p) represented by the following Equation 11:

$$f ( {x}_{i} , {x}_{j} , \text{?} , p ) = \text{?} s ( l , {x}_{j} , \text{?} , p ) d l = \text{?} {a}_{1} ( p ) d l + \text{?} {a}_{2} ( p ) d l + \text{?} {a}_{3} ( p ) d l + \text{?} {a}_{4} ( p ) d l + \text{?} {a}_{5} ( p ) d l \\ \text{?} \text{indicates text missing or illegible when filed} \qquad [ Equation . 11 ]$$

where: xᵢ is the scan length of the scan path; xⱼₛ is a starting point of a first shaped object adjacent to the scan path scanned across the scan length xᵢ; xⱼₑ is an end point of the first shaped object adjacent to the scan path scanned across the scan length xᵢ; xₖₛ is a starting point of a second shaped object adjacent to the scan path scanned across the scan length xᵢ, and the starting point of the second shaped object exists between the starting point of the first shaped object and the end point of the first shaped object; xₖₑ is an end point of the second shaped object adjacent to the scan path scanned across the scan length xᵢ, and the end point of the second shaped object exists between the starting point of the first shaped object and the end point of the first shaped object; p is a shaping parameter of the manufacturing process; a₁ is a shrinkage rate per unit length of the scan path, which fluctuates with the shaping parameter, having a length from the starting point of the scan path scanned across the scan length xᵢ to the point xⱼₛ; a₂ is a shrinkage rate per unit length of the scan path, which fluctuates with the shaping parameter, having a length from the point xⱼₛ to the point xₖₛ; a₃ is a shrinkage rate per unit length of the scan path, which fluctuates with the shaping parameter, having a length from the point xₖₛ to the point xₖₑ; a₄ is a shrinkage rate per unit length of the scan path, which fluctuates with the shaping parameter, having a length from the point xₖₑ to the point xⱼₑ; a₅ is a shrinkage rate per unit length of the scan path, which fluctuates with the shaping parameter, having a length from the point xⱼₑ to the point xᵢ; and s(l, xⱼ, xₖ, p) is a shrinkage rate per unit length of the material and represented by the following Equation 12:

$$s ( l , {x}_{j} , {x}_{k} , p ) = \{ \begin{matrix}{a}_{1} ( p ) & ( 0 \leq l < {x}_{js} ) \\ {a}_{2} ( p ) & ( {x}_{js} \leq l < \text{?} ) \\ {a}_{3} ( p ) & ( \text{?} \leq l < \text{?} ) \\ {a}_{4} ( p ) & ( \text{?} \leq l < {x}_{je} ) \\ {a}_{5} ( p ) & ( \text{?} \leq l < {x}_{i} )\end{matrix} \\ \text{?} \text{indicates text missing or illegible when filed} \qquad [ Equation . 12 ]$$

In one embodiment of the present invention, the formulation means can formulate the shrinkage as a shrinkage function with a constraint condition of a length in response to a break of the material caused by the shrinkage of the material when the scan path is irradiated with laser. The constraint condition of the length can be that the scan length x does not exceed a length at which the break occurs due to the shrinkage of the material.

In one embodiment of the present invention, the formulation means can formulate the shrinkage by dividing the scan path into a plurality of paths in response to a break of the material caused by the shrinkage of the material when the scan path is irradiated with laser.

In one embodiment of the present invention, the optimization calculation can be performed according to the following Equation 13:

$$min [ {\sum }_{i} {\{ {X}_{i} - f ( {x}_{i} ) \}}^{2} ] \qquad [ Equation . 13 ]$$

where: Xᵢ is a design value of the (expected) scan path of the three-dimensional structure; ƒ(xᵢ) is a shrinkage function; and xᵢ is the scan length (optimization variable) of the scan path.

In one embodiment of the present invention, the optimization calculation means can perform the optimization calculation according to the constraint condition of the thickness of the surplus growth. The constraint condition of the thickness of the surplus growth can include the maximum curing depth and that the maximum curing depth Zₘₐₓ is obtained by solving E(0, zₘₐₓ)=Ec in order to obtain the thickness of the surplus growth, and the character E_{c} can be a critical exposure amount.

A computer program according to an embodiment of the present invention can be stored onto an arbitrary computer-readable recording medium such as one or more flexible disks, an MO, a CD-ROM, a DVD, a BD, a hard disk device, a memory medium connectable to a USB port, a ROM, an MRAM, a RAM, or the like. In order to store the computer program onto the recording medium, the computer program can be downloaded from another computer connected via a communication line such as, for example, a server computer or can be copied from another recording medium. Moreover, the computer program according to an embodiment of the present invention can also be compressed or divided into a plurality of components so as to be stored on a single recording medium or a plurality of recording media. Furthermore, note that naturally a computer program product according to an embodiment of the present invention can be provided in various forms. A computer program product according to an embodiment of the present invention can include, for example, a recording medium in which the above computer program is recorded or a transmission medium which transmits the above computer program.

Note that the above-mentioned summary of the present invention does not list all features necessary for the present invention and that a combination of these components or sub-combinations thereof can also constitute the present invention.

Naturally, it can be easily supposed by a person skilled in the art to perform various modifications such as to combine the hardware components of the computer used in embodiments of the present invention with a plurality of machines to distribute and implement functions to the machines. Those modifications are naturally concepts included in the ideas of the present invention. These components are illustrative only, however, and all of the components are not necessarily the essential features of the present invention.

Moreover, the present invention is achievable with hardware, software, or a combination of hardware and software. Regarding the execution with the combination of hardware and software, there is an execution in a computer in which the aforementioned computer program is installed as a typical example. In this case, the computer program is loaded into the memory of the computer and executed, by which the computer program controls the computer to perform the processing according to the present invention. The computer program can be constituted by a group of instructions representable by an arbitrary language, code, or description. Such a group of instructions enables the computer to perform specific functions directly or to perform processing according to an embodiment of the present invention after the execution of one of or both of (1) conversion to any other language, code, or description and (2) copying to other media.

Data provided according to an embodiment of the present invention is a scan length modified in such a way as to minimize a difference between the dimensions of the three-dimensional structure formed by laser radiation and the design values of a scan path of the three-dimensional structure. This leads to solving the problem of the accuracy of dimensions which occurs in manufacturing the three-dimensional structure formed by laser radiation. Moreover, since the accuracy of dimensions is solved, the degree of freedom in devising an appropriate material of the conventional technique (for example, mixing an acrylic resin and an epoxy resin as described above) is improved. Therefore, the constraints imposed to reduce the shrinkage rate in the material design are eased, which enables material design with higher degree of freedom. This enables, for example, a design for increasing the strength of a three-dimensional structure or for improving the heat resistance of the three-dimensional structure.

Embodiments of the present invention are described in detail hereinafter with reference to accompanying drawings. Unless otherwise specified, like reference numerals denote like elements throughout the drawings below. It can be understood that embodiments of the present invention are provided to illustrate the preferred embodiments of the present invention only and are not intended to limit the scope of the present invention to the particular illustrative embodiments described here.

A computer which can be used in an embodiment of the present invention is not particularly limited as long as it has the computing power of providing data for minimizing a difference between the dimensions of the three-dimensional structure formed by laser radiation and the design values of a scan path of the three-dimensional structure. The computer can be, for example, a desktop computer, a notebook computer, an all-in-one personal computer, a server, or a tablet terminal.

The computer which can be used in an embodiment of the present invention can be connected to a three-dimensional structure manufacturing machine via a wired connection (for example, a USB cable or a network cable) or wireless connection or can be included in the three-dimensional structure manufacturing machine in a nondetachable form.

In an embodiment of the present invention, “a three-dimensional structure formed by laser radiation” includes a three-dimensional structure manufactured in the stereolithography or a three-dimensional structure manufactured in the selective laser sintering method.

If the “three-dimensional structure formed by laser radiation” is the three-dimensional structure manufactured in the stereolithography, the laser can be, for example, ultraviolet light or visible-light laser, and the material is, for example, a photo-curable substance (for example, photo-curable resin) which is a liquid.

An example of manufacturing a three-dimensional structure in the stereolithography is as described below. The three-dimensional structure manufacturing machine acquires one uniform curing line by scanning a scan path at predetermined laser power and predetermined laser scan speed. Thereafter, the three-dimensional structure manufacturing machine acquires the subsequent curing line by scanning the subsequent scan path in such a way that a curing line slightly overlaps the above acquired curing line. The three-dimensional structure manufacturing machine acquires a planar cured layer by repeating the above scanning of the scan path. The three-dimensional structure manufacturing machine further repeats the above scanning of the scan path in the height direction to manufacture a three-dimensional structure.

A photo-curable resin, which can be used in the stereolithography, can be an arbitrary resin used in the stereolithography. Although the material which can be used in the stereolithography can be generally a composition composed of monomer, oligomer, photopolymerization initiator, and various additive agents (for example, stabilizer, filler, and pigment), the material which can be used in the present invention is not limited thereto.

A three-dimensional structure manufacturing machine for use in manufacturing a three-dimensional structure in the stereolithography can be an arbitrary manufacturing machine which can be used in the stereolithography. The three-dimensional structure manufacturing machine can manufacture a three-dimensional structure, for example, in the stereolithography of the XY scanning free liquid level system or the liquid level regulating system.

If the three-dimensional structure formed by laser radiation is a three-dimensional structure manufactured in the selective laser sintering method, the laser can be, for example, carbon dioxide laser or YAG laser, and the material can be, for example, plastic, rubber, metal, ceramics, sand (for example, casting core sand), or wax.

An example of manufacturing the three-dimensional structure in the selective laser sintering method is as described below. The three-dimensional structure manufacturing machine radiates laser through a galvanometer mirror on powder uniformly laid on a container for manufacturing the three-dimensional structure in order to solidify only the irradiated area. The three-dimensional structure manufacturing machine manufactures a three-dimensional structure by repeating the scanning to layer a shaped object.

The three-dimensional structure manufacturing machine for use in manufacturing a three-dimensional structure in the selective laser sintering method can be an arbitrary manufacturing machine which can be used in the selective laser sintering method.

FIG. 1 is a diagram illustrating an example of a hardware configuration for implementing a computer which can be used in an embodiment of the present invention. The computer (101) includes a CPU (102) and a main memory (103), which are connected to a bus (104). The CPU (102) is preferably based on a 32-bit or 64-bit architecture. The CPU (102) can be, for example, of the Core™ i series, Core™ 2 series, Atom™ series, Xeon® series, Pentium® series, or Celeron® series from Intel corporation, of the A series, Phenom™ series, Athlon™ series, Turion™ series, or Sempron™ from Advanced Micro Devices (AMD) Inc., or of the Power™ series from International Business Machines Corporation.

The bus (104) can be connected to a display (106) such as, for example, a liquid crystal display (LCD) via a display controller (105). The liquid crystal display (LCD) can be, for example, a touch panel display or a floating touch display. The display (106) can be used for displaying an object, which is displayed by the operation of software such as, for example, a computer program according to an embodiment of the present invention running on the computer (101), on an appropriate graphic interface.

The bus (104) can be arbitrarily connected to a disk (108) such as, for example, a hard disk or solid state drive (SSD) via, for example, a SATA or IDE controller (107). The bus (104) can be arbitrarily connected to a drive (109) such as, for example, a CD, DVD, or BD drive via, for example, a SATA or IDE controller (107). The bus (104) can be arbitrarily connected to a keyboard (111), a mouse (112) and/or a track pad via a peripheral device controller (110) such as, for example, a keyboard/mouse controller or a USB bus.

The disk (108) can store an operating system such as, Windows® OS, UNIX®, or Mac OS®, a Java® processing environment such as J2EE, a Java® application, a Java® virtual machine (VM), a program providing a Java® just-in-time (JIT) compiler, a computer program according to an embodiment of the present invention, other programs, and data in such a way that these are loadable in the main memory (103).

The disk (108) can be built in a computer (101), can be connected to the computer (101) via a cable so that the computer (101) is able to access to the disk (108), or can be connected to the computer (101) via a wired or wireless network so that the computer (101) is able to access to the disk (108).

The drive (109) can be used to install a program such as, for example, an operating system, an application, or a computer program according to an embodiment of the present invention from a CD-ROM, a DVD-ROM, or a BD to the disk (108), if necessary.

A communication interface (114) conforms to, for example, the Ethernet® protocol. The communication interface (114) is connected to the bus (104) via a communication controller (113), plays a role of connecting the computer (101) to a communication line (115) via a wired or wireless connection, and provides the TCP/IP communication protocol of a communication function of the operating system of the computer (101) with a network interface layer. The communication line can be in, for example, a wireless LAN environment based on the wireless LAN connection standard, a Wi-Fi wireless LAN environment such as IEEE 802.11a/b/g/n, or a mobile telephone network environment (for example, a 3G or 4G environment).

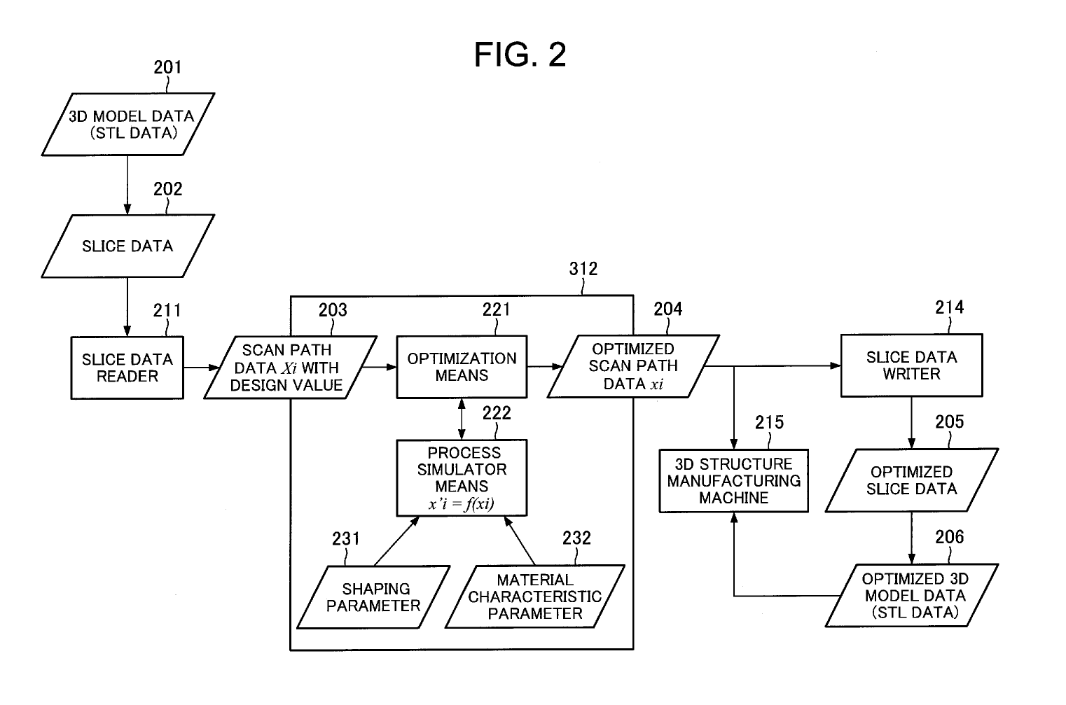

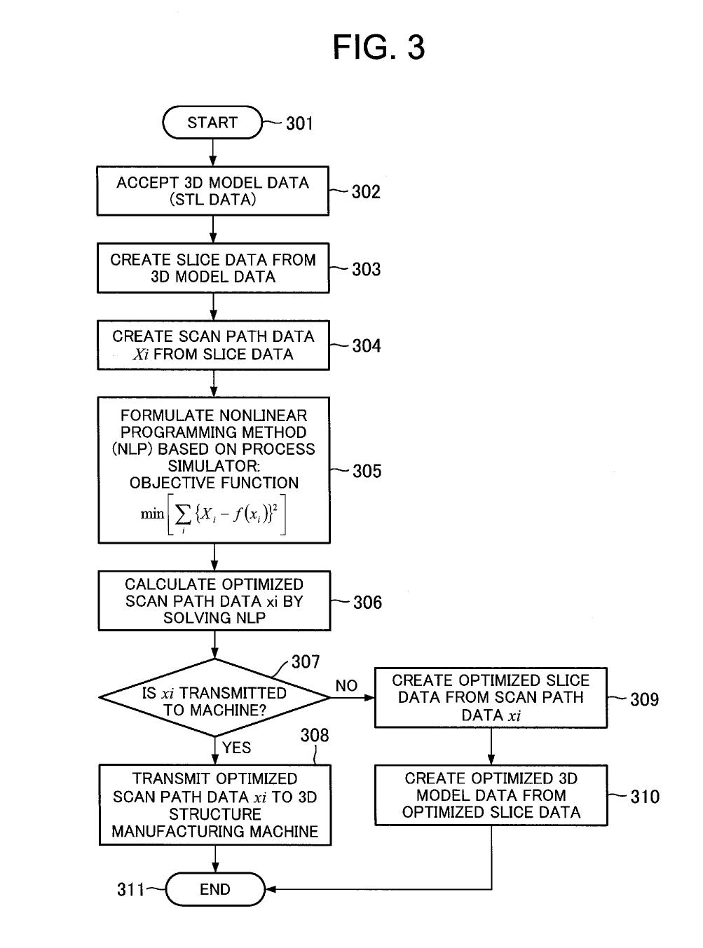

FIG. 2 is a block diagram for providing scan path data for minimizing a difference between the dimensions of a three-dimensional structure formed by laser radiation and the design values of a scan path of the three-dimensional structure (hereinafter, also referred to as optimized scan path data), slice data optimized based on the optimized scan path data, and three-dimensional model data optimized based on the optimized slice data (for example, STL [stereolithography or standard triangulated language] data) according to an embodiment of the present invention. FIG. 3 is a flowchart for providing the aforementioned optimized scan path data, the aforementioned optimized slice data, and the aforementioned optimized three-dimensional model data according to the block diagram illustrated in FIG. 2.

The following describes an embodiment with reference to the flowchart illustrated in FIG. 3, while description is made with reference to the block diagram illustrated in FIG. 2.

In step 301, the computer starts processing for providing the optimized scan path data, the optimized slice data, and the optimized STL data.

In step 302, the user prepares three-dimensional model data (for example, STL data) (block 201) and then inputs the data into the computer (101). The computer (101) accepts the three-dimensional model data and stores the data into, for example, a recording medium (for example, the recording medium [108] in FIG. 1) to which the computer (101) is able to access. The three-dimensional model data can be prepared by converting, for example, three-dimensional solid data input on the three-dimensional CAD to STL data.

In step 303, the computer (101) provides slice data (block 202) from the three-dimensional model data accepted in step 301. The slice data (block 202) can be data acquired by slicing an expected three-dimensional structure into a plurality of N layers. The slice data (block 202) can be, for example, data provided by slicing the expected three-dimensional structure at regular intervals (for example, 0.05 to 0.18 mm) in the shaping height direction. The slice data (block 202) can include two-dimensional coordinate data.

In step 304, the computer (101) reads the slice data provided in step 302 into a slice data reader (block 211). The aforementioned slice data reader (block 211) provides scan path data Xᵢ (also referred to as laser scan line data) from the aforementioned slice data having been read (block 203). The term “scan path” means a route on which the laser scans. The scan path data Xᵢ (block 203) includes a scan length x represented by a design value.

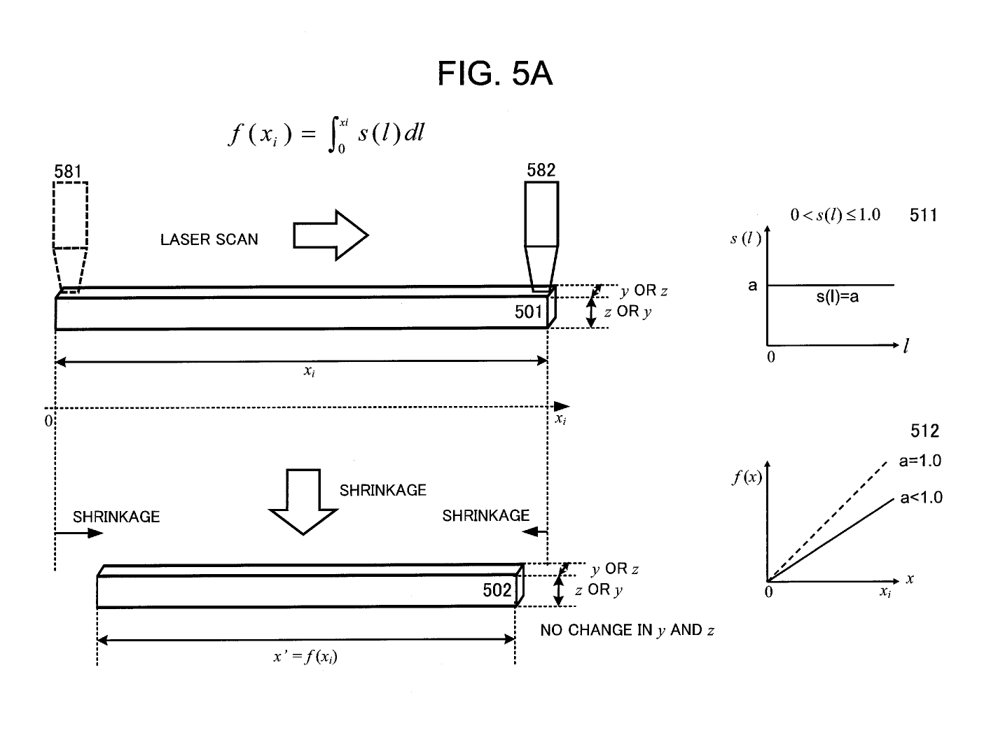

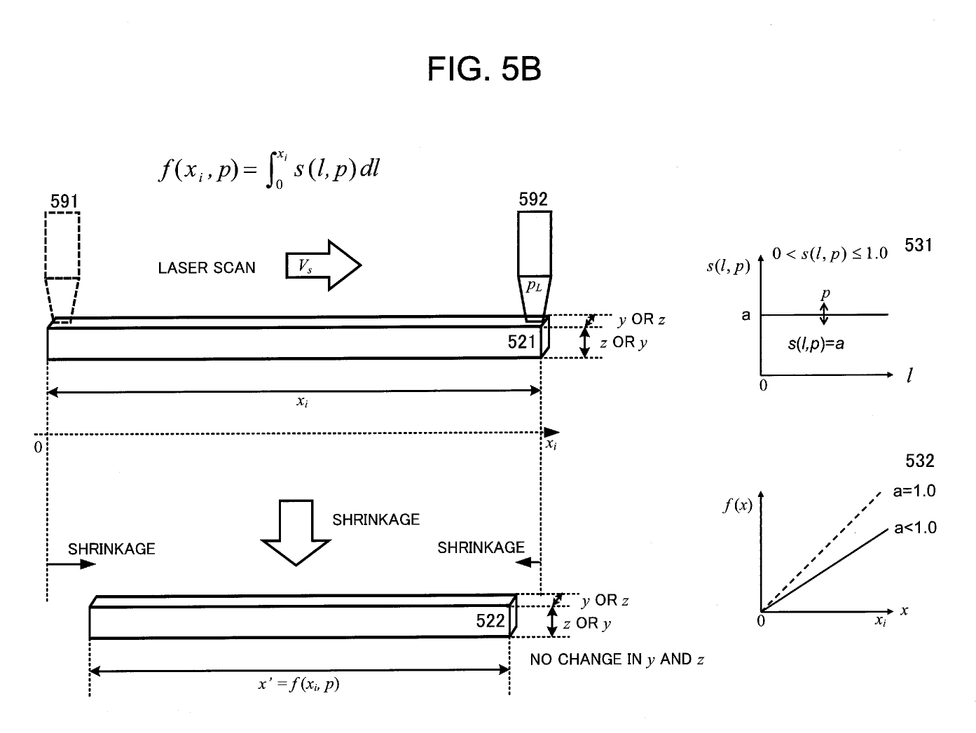

In step 305, the computer (101) transmits the scan path data Xᵢ (block 203) to optimization means (block 221). The optimization means (block 221) receives the scan path data Xᵢ (block 203). The optimization means (block 221) passes the process to simulator means (block 222) in order to formulate a shrinkage of the material used in the manufacturing process. The process simulator means (block 222) formulates the aforementioned shrinkage. Examples of shrinkage functions are illustrated in FIGS. 5A and 5B, FIGS. 6A and 6B, FIGS. 7A and 7B, and FIGS. 8A and 8B, and FIG. 9 described below.

The process simulator means (block 222) can formulate the aforementioned shrinkage by using shaping parameters (process parameters) p (block 231). Although the shaping parameters p (block 231) are, for example, as described below, the shaping parameters p are not limited thereto.
Laser power (m W): P_{L};
Laser scan speed (cm/s): Vₛ;
Laser beam radius (μm): Wₒ;
Layer thickness (μm): L_{T};
Hatch spacing (μm): hₛ;
Total number of layers: l; and
Order of laser scan: O.

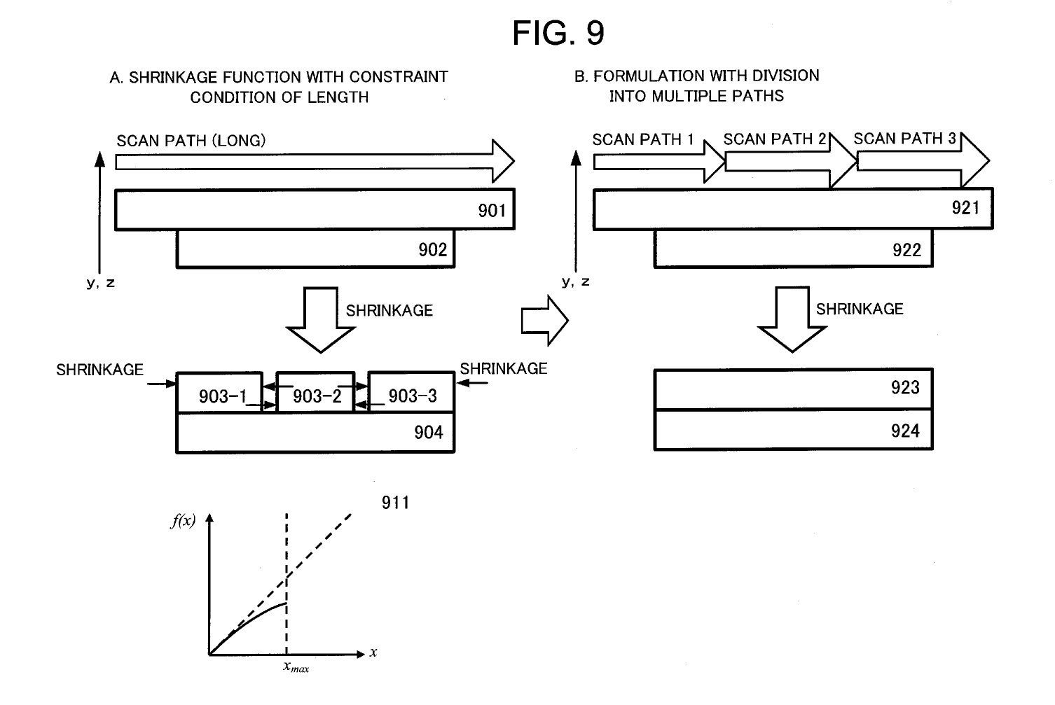

Moreover, the process simulator means (block 222) can perform the formulation of the shrinkage as a shrinkage function with a constraint condition of a length in response to the break of the material caused by the shrinkage of the material when the scan path is irradiated with laser. The constraint condition of the length is that the scan length x does not exceed the length at which the break occurs due to the shrinkage of the material. The shrinkage function with the constraint condition of the length is described with reference to FIG. 9 below.

Moreover, the process simulator means (block 222) can divide the scan path into a plurality of paths and formulate the shrinkage with respect to each divided path in response to the break of the material caused by the shrinkage of the material when the scan path is irradiated with laser. The details of the division into the plurality of paths and the formulation is described with reference to FIG. 9 below.

Moreover, the process simulator means (block 222) can add, for example, a constraint condition of the thickness of the surplus growth to the formulated objective function and constraint condition, in other words, a problem of the nonlinear programming method (NLP). The constraint condition of the thickness of the surplus growth includes material characteristic parameters m (block 232). While the material characteristic parameters m (block 232) are, for example, as described below, the material characteristic parameters m are not limited thereto. Critical exposure amount (mJ/cm²): E_{C}; Penetration depth (μm): Dₚ; Viscosity (Pa*s); and Material density (g/cm³).

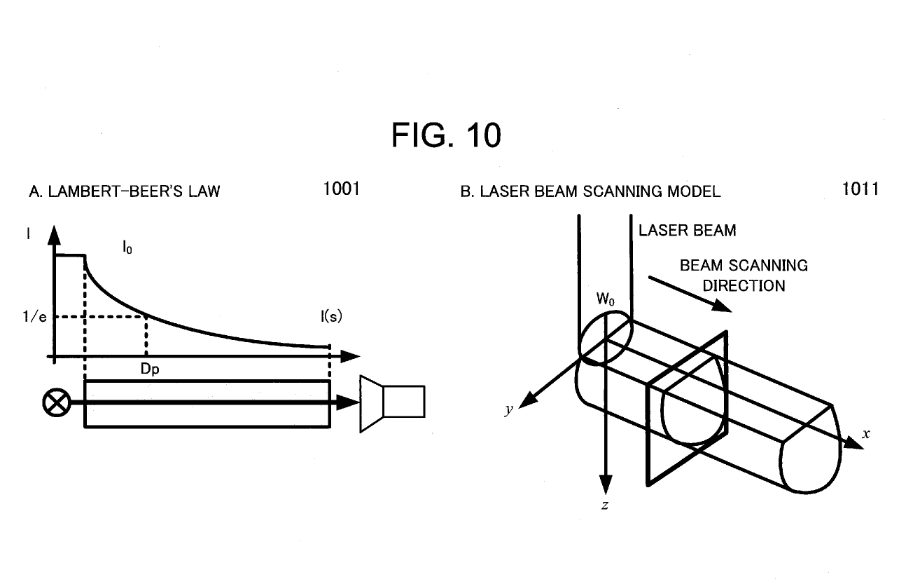

The constraint condition of the thickness of the surplus growth can include, for example, the maximum curing depth. If the constraint condition of the thickness of the surplus growth includes the maximum curing depth, the optimization means (block 221) can include obtaining the maximum curing depth zₘₐₓ by solving E(0, Zₘₐₓ)=E_{c} in order to obtain the surplus growth rate. The details of performing the optimization calculation according to the constraint condition of the thickness of the surplus growth is described with reference to FIG. 10 below.

The computer (101) sets up an expression of the objective function and the constraint condition on the basis of the formulated shrinkage model and then returns the process to the optimization means (block 221).

As described above, in step 305, a physical phenomenon is formulated. Thereafter, in step 306 below, the problem of the formulated nonlinear programming method (NLP) is solved.

In step 306, the computer (101) solves the formulated objective function and constraint condition, in other words, the problem of the nonlinear programming method (NLP) and computes the optimized scan path data xᵢ (block 204).

The optimization means (block 221) computes the optimized scan path data xᵢ (block 204) from the received scan path data Xᵢ (block 203) by using the formulated shrinkage model. The optimization means (block 221) computes the scan path data xᵢ (block 204) so as to satisfy the objective function conforming to the following Equation 13:

$$min [ {\sum }_{i} {\{ {X}_{i} - f ( {x}_{i} ) \}}^{2} ] \qquad [ Equation . 13 ]$$

where: Xᵢ is the design value of the scan path of the three-dimensional structure; ƒ(xᵢ) is a shrinkage function; and xᵢ is a scan length (optimization variable) of the scan path.

The Equation 13 means the computation of the minimum value of a difference between the design value of a scan path of the three-dimensional structure and the dimension of the three-dimensional structure actually formed by laser.

In step 307, the computer (101) determines whether to transmit the optimized scan path data xᵢ (block 204) acquired in step 306 to the three-dimensional structure manufacturing machine (block 215). If determining to transmit the scan path data xᵢ (block 204) to the three-dimensional structure manufacturing machine (block 215), the computer (101) proceeds the process to step 308. On the other hand, if determining not to transmit the scan path data xᵢ (block 204) to the three-dimensional structure manufacturing machine (block 215), the computer (101) proceeds the process to step 309.

In step 308, the computer (101) transmits the scan path data xᵢ (block 204) to the three-dimensional structure manufacturing machine (block 215). The three-dimensional structure manufacturing machine (block 215) receives the scan path data xᵢ (block 204) and manufactures a three-dimensional structure on the basis of the received scan path data xᵢ.

In step 309, the computer (101) transmits the scan path data xᵢ (block 204) computed in step 306 to a slice data writer (block 214). The slice data writer (block 214) provides optimized slice data (block 205) from the scan path data xᵢ (block 204).

In step 310, the computer (101) provides optimized three-dimensional model data (for example, STL data) (block 206) from the optimized slice data (block 205) provided in step 309. The computer (101) can store the provided three-dimensional model data (block 206) into a recording medium to which the computer (101) is able to access (for example, the storage medium [108] in FIG. 1) or a recording medium to which the three-dimensional structure manufacturing machine (block 215) is able to access.

In step 311, the computer (101) ends the processing for providing the optimized scan path data, the optimized slice data, and the optimized three-dimensional model data.

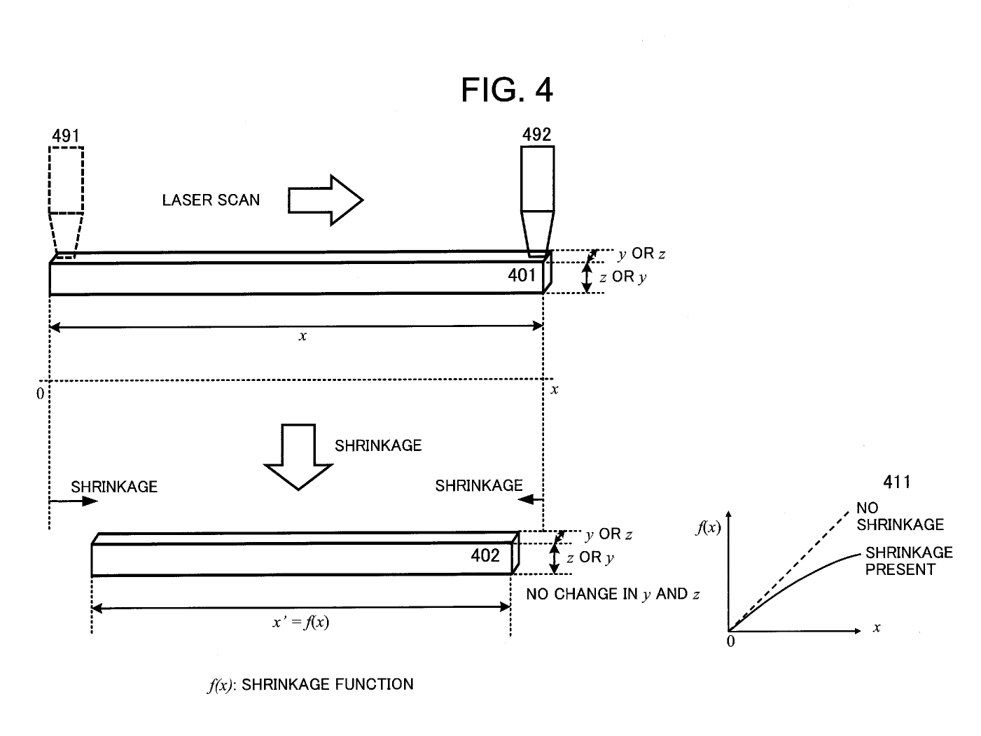

In FIG. 4, FIGS. 5A and 5B, FIGS. 6A and 6B, FIGS. 7A and 7B, and FIGS. 8A and 8B, and FIG. 9, there are illustrated examples of the formulation with the shrinkage function in the case where the material shrinks according to an embodiment of the present invention. Note that, in the examples illustrated in FIG. 4, FIGS. 5A and 5B, FIGS. 6A and 6B, FIGS. 7A and 7B, and FIGS. 8A and 8B, and FIG. 9, for example, the scan length, the shrinkage rate, the length after shrinkage, and the graph are illustrated schematically for convenience in order to describe the shrinkage function and thus these do not intend the accurate scan length, shrinkage rate, length after shrinkage, and graph.

FIG. 4 illustrates a block diagram for modeling the manufacturing process of the three-dimensional structure and formulating the shrinkage of the material for use in the manufacturing process according to an embodiment of the present invention.

It is assumed that a laser scans an area from an end (491) to an end (492) of the scan length x of the scan path (401) which is a design value with a laser beam. On the scan path (401), there can be a liquid photo-curable resin which is the material in the case of using the stereolithography, while there can be laid powder which is the material in the case of using the powder sintering shaping method. It is assumed that the material for use in forming a shaped object which is a part of the three-dimensional structure has shrunk as a result of the laser scan. It is assumed that the length of the shaped object after the shrinkage, which corresponds to the scan length x and which is a part of the three-dimensional structure formed by the laser scan, has a value x′ (402). Further, it is assumed that there is no shrinkage of the material in the width (y-axis) direction and in the depth (z-axis) direction associated with the scan length x or that the shrinkage is within the margin of error. In other words, it is assumed that there is no change in the length of the material on the y axis and on the z axis or the change is within the margin of error.

The length x′ (502) of the shaped object after the shrinkage can be represented by x′=ƒ(x), where ƒ(x) is a shrinkage function. If the shrinkage depends on the scan length x, the computer (101) formulates the shrinkage function as ƒ(x).

A graph (411) illustrates a relationship between the scan length x and the shrinkage function ƒ(x). If there is no shrinkage, there is a linearity relationship represented by ƒ(x)=x between the scan length x and the shrinkage function ƒ(x) (no shrinkage). If there is a shrinkage, a straight line or a curve line is drawn in the range to the lower right of the straight line represented by ƒ(x)=x. A graph (411) illustrates a shrinkage function in the case where the shrinkage level (shrinkage rate) increases with the increase in the scan length x (there is a shrinkage).

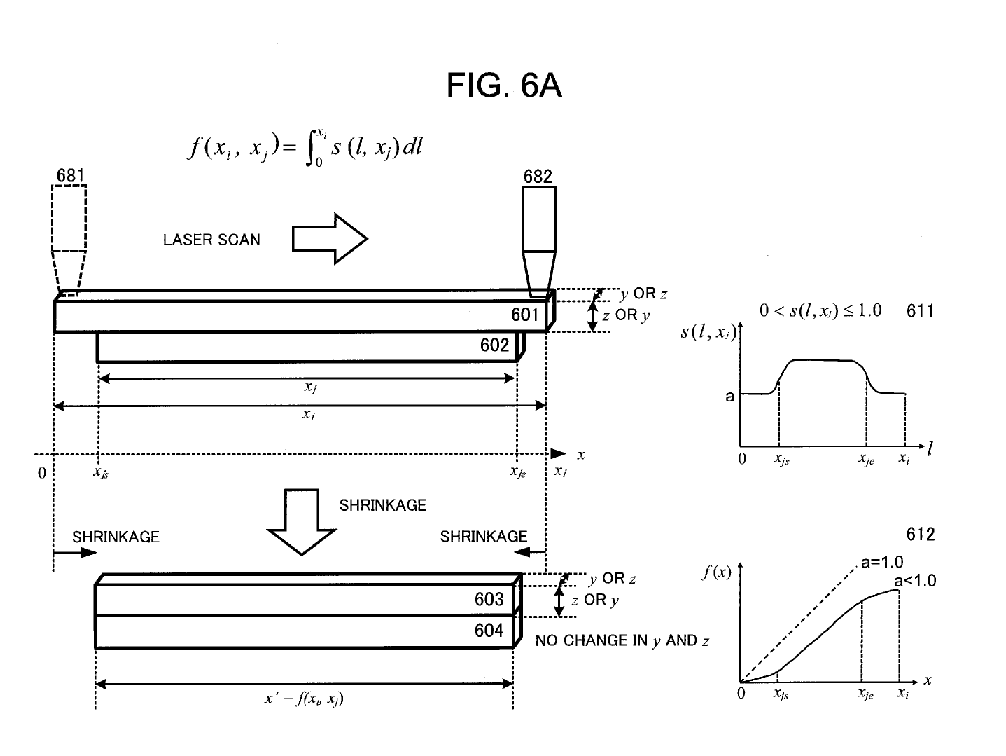

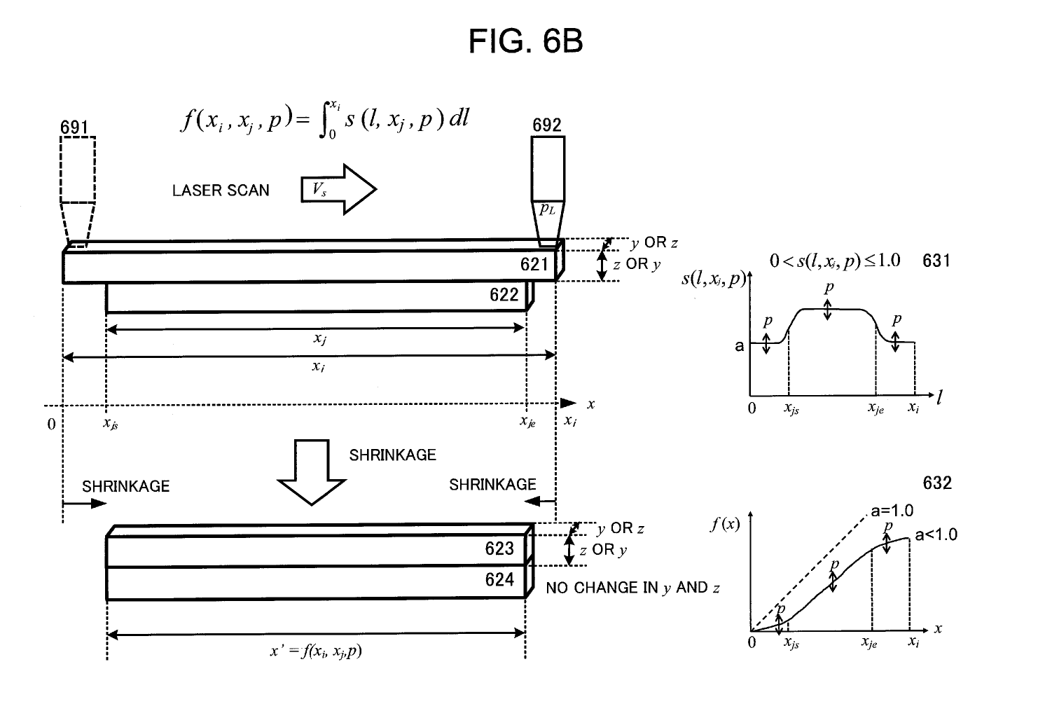

In FIGS. 5A and 5B, FIGS. 7A and 7B, FIGS. 8A and 8B, and FIG. 9 described below, there is illustrated an embodiment in which the shrinkage rate is represented by a linear line in the case where there is a shrinkage of the material. In FIGS. 6A and 6B described below, there is illustrated an embodiment in which the shrinkage rate is represented by a curved line in the case where there is a shrinkage of the material.

FIG. 5A illustrates a block diagram for modeling the manufacturing process of the three-dimensional structure and formulating the shrinkage of the material for use in the manufacturing process according to an embodiment of the present invention.

It is assumed that the laser scans an area from an end (581) to an end (582) of the scan length xᵢ of the scan path (501) which is a design value with a laser beam. It is assumed that the material for use in forming the shaped object which is a part of the three-dimensional structure has shrunk as a result of the laser scan. It is assumed that the length of the shaped object after the shrinkage, which corresponds to the scan length xᵢ and which is a part of the three-dimensional structure formed by the laser scan, has a value x′ (502). Further, it is assumed that there is no shrinkage of the material in the width (y-axis) direction and in the depth (z-axis) direction associated with the scan length xᵢ or that the shrinkage is within the margin of error.

The length x′ (502) of the shaped object after the shrinkage can be represented by x′=ƒ(x), where ƒ(x) is a shrinkage function and is represented by the following Equation 1. If the above shrinkage depends on the scan length xᵢ, the computer (101) formulates the shrinkage function as the aforementioned ƒ(x). The shrinkage function represented by the following Equation 1 can assume that there is no environment affecting the aforementioned scan path (for example, in the case where there is formed the shaped object, which is a part of the three-dimensional structure adjacent to the aforementioned scan path and having already been laser-scanned) and that there is no effect by the shaping parameters.

ƒ(xᵢ)=∫₀^{xi}s(l)dl [Equation. 1]

where: xᵢ is the scan length of a scan path; and s(l) is a shrinkage rate per unit length of the material.

If s(l) has a value of 1.0, it means that the material does not shrink. If s(l) has a value of, for example, 0.9, it means that the 10% of the material shrinks, thereby obtaining a shaped object having the length of 90% of the scan length xᵢ.

A graph (511) illustrates that the shrinkage rate stays constant at value a (s(l)=a) and is in a range of 0<s(l)≦1.0. Generally, if the shrinkage rate is 1%, value “a” can be, for example, 0.99.

A graph (512) illustrates a relationship between the scan length xᵢ and the shrinkage function ƒ(x) in the case of the absence of shrinkage (a=1.0) and in the case of the presence of shrinkage (a<1.0).

FIG. 5B illustrates a block diagram for modeling the manufacturing process of the three-dimensional structure and formulating the shrinkage of the material for use in the manufacturing process according to an embodiment of the present invention.

It is assumed that the laser scans an area from an end (591) to an end (592) of the scan length xᵢ of the scan path (521) which is a design value with a laser beam. It is assumed that the material for use in forming the shaped object which is a part of the three-dimensional structure has shrunk as a result of the laser scan. It is assumed that the length of the shaped object after the shrinkage, which corresponds to the scan length xᵢ and which is a part of the three-dimensional structure formed by the laser scan, has a value x′ (522). Further, it is assumed that there is no shrinkage of the material in the width (y-axis) direction and in the depth (z-axis) direction associated with the scan length xᵢ or that the shrinkage is within the margin of error.

The length x′ (522) of the shaped object after the shrinkage can be represented by x′=ƒ(x, p), where ƒ(x, p) is a shrinkage function and is represented by the following Equation 2. If the above shrinkage depends on the scan length xᵢ, the computer (101) formulates the shrinkage function as the aforementioned ƒ(x, p). The shrinkage function represented by the following Equation 2 can assume that there is no environment affecting the aforementioned scan path (for example, in the case where there is formed the shaped object, which is a part of the three-dimensional structure adjacent to the aforementioned scan path and having already been laser-scanned). The aforementioned shaping parameters can be, for example, laser power (P_{L}) and laser scan speed (Vₛ).

ƒ(x_{i,}p)=∫₀^{xi}s(l,p)dl [Equation. 2]

where: x is the scan length of the scan path; s(l, p) is a shrinkage rate per unit length of the material; and p is a shaping parameter of a manufacturing process in FIG. 5B according to an embodiment.

A graph (531) illustrates that the shrinkage rate stays constant at value a (s(l, p)=a), though fluctuating with the shaping parameter p, and the shrinkage rate is in a range of 0<s(l, p)≦1.0.

A graph (532) illustrates a relationship between the scan length xᵢ and the shrinkage function ƒ(x, p) in the case of the absence of shrinkage (a=1.0) and in the case of the presence of shrinkage (a<1.0).

FIG. 6A illustrates a block diagram for modeling the manufacturing process of the three-dimensional structure and formulating the shrinkage of the material for use in the manufacturing process according to an embodiment of the present invention.

It is assumed that the laser scans an area from an end (681) to an end (682) of the scan length xᵢ of the scan path (601) which is a design value with a laser beam. Moreover, it is assumed that there is a shaped object (602), which is directly adjacent to the scan path (601) and which is a part of the three-dimensional structure having already been formed by laser scan. The length of the shaped object (602), which is a part of the three-dimensional structure, has a value xⱼ. It is assumed that the material for use in forming the shaped object which is a part of the three-dimensional structure has shrunk as a result of the laser scan. It is assumed that the length of the shaped object after the shrinkage, which corresponds to the scan length xᵢ and which is a part of the three-dimensional structure formed by the laser scan, has a value xᵢ′ (603). Further, it is assumed that there is no shrinkage of the material in the width (y-axis) direction and in the depth (z-axis) direction associated with the scan length xᵢ or that the shrinkage is within the margin of error. Moreover, the shaped object (602) which is a part of the three-dimensional structure corresponds to a shaped object (604) which is a part of the three-dimensional structure after the shrinkage and does not shrink with the laser scan.

The length xᵢ′ (603) of the shaped object after the shrinkage can be represented by xᵢ′=ƒ(xᵢ, xⱼ), where ƒ(xᵢ, xⱼ) is a shrinkage function and is represented by the following Equation 3. If the above shrinkage depends on the scan length xᵢ and the neighboring scan path, the computer (101) formulates the shrinkage function as the aforementioned ƒ(xᵢ, xⱼ). The shrinkage function represented by the following Equation 3 can assume that there is an environment affecting the aforementioned scan path (the scan length in the case where there is formed a shaped object which is a part of the three-dimensional structure adjacent to the aforementioned scan path and having already been laser-scanned) and that there is no effect of the shaping parameters.

ƒ(x_{_{i,}}x_{ᵢ})=∫₀^{xi}s(l,xⱼ)dl [Equation. 3]

where: xᵢ is the scan length of the scan path; s(l, xⱼ) is a shrinkage rate per unit length of the material; and xⱼ is the length of the shaped object of the scan path adjacent to the scan path scanned across the scan length xᵢ.

A graph (611) illustrates that the shrinkage rate fluctuates in the ranges of the scan length: 0 to xⱼₛ; xⱼₛ to xⱼₑ; and xⱼₑ to xᵢ, and the shrinkage rate is in a range of 0<s(l, xⱼ)≦1.0.

A graph (612) illustrates a relationship between the scan length xᵢ and the shrinkage function ƒ(xᵢ, xⱼ) in the case of the absence of shrinkage (a=1.0) and in the case of the presence of shrinkage (a<1.0).

FIG. 6B illustrates a block diagram for modeling the manufacturing process of the three-dimensional structure and formulating the shrinkage of the material for use in the manufacturing process according to an embodiment of the present invention.

It is assumed that the laser scans an area from an end (691) to an end (692) of the scan length xᵢ of the scan path (621) which is a design value with a laser beam. Moreover, it is assumed that there is a shaped object (622), which is directly adjacent to the scan path (621) and which is a part of the three-dimensional structure having already been formed by laser scan. The length of the shaped object (622), which is a part of the three-dimensional structure, has a value xⱼ. It is assumed that the material for use in forming the shaped object which is a part of the three-dimensional structure has shrunk as a result of the laser scan. It is assumed that the length of the shaped object after the shrinkage, which corresponds to the scan length xᵢ and which is a part of the three-dimensional structure formed by the laser scan, has a value xᵢ′ (623). Further, it is assumed that there is no shrinkage of the material in the width (y-axis) direction and in the depth (z-axis) direction associated with the scan length xᵢ or that the shrinkage is within the margin of error. Moreover, the shaped object (622) which is a part of the three-dimensional structure corresponds to a shaped object (624) which is a part of the three-dimensional structure after the shrinkage and does not shrink with the laser scan.

The length xᵢ′ (623) of the shaped object after the shrinkage can be represented by xᵢ′=ƒ(xᵢ, xⱼ, p), where ƒ(xᵢ, xⱼ, p) is a shrinkage function and is represented by the following Equation 4. If the above shrinkage depends on the scan length xᵢ, a neighboring scan path, and shaping parameters, the computer (101) formulates the shrinkage function as the aforementioned ƒ(xᵢ, xⱼ, p). The shrinkage function represented by the following Equation 4 can assume that there is an environment affecting the aforementioned scan path (for example, the scan length in the case where there is formed a shaped object which is a part of the three-dimensional structure adjacent to the aforementioned scan path and having already been laser-scanned) and that there is no effect of the shaping parameters. The aforementioned shaping parameters can be laser power (P_{L}) and laser scan speed (Vₛ).

ƒ(xᵢ,xⱼ,p)=∫₀^{xi}s(l,xⱼ,p)dl [Equation. 4]

where: xᵢ is the scan length of the scan path; s(l, xⱼ, p) is a shrinkage rate per unit length of the material; xⱼ is the length of the shaped object of the scan path adjacent to the scan path scanned across the scan length xᵢ; and p is a shaping parameter of the manufacturing process according to an embodiment in FIG. 6B.

A graph (631) illustrates that the shrinkage rate fluctuates in the ranges of the scan length: 0 to xⱼₛ; xⱼₛ to xⱼₑ; and xⱼₑ to xᵢ, though fluctuating with the shaping parameter p, and the shrinkage rate is in a range of 0<s(l, xⱼ, p)≦1.0.

A graph (632) illustrates a relationship between the scan length xᵢ and the shrinkage function ƒ(xᵢ, xⱼ, p) in the case of the absence of shrinkage (a=1.0) and in the case of the presence of shrinkage (a<1.0).

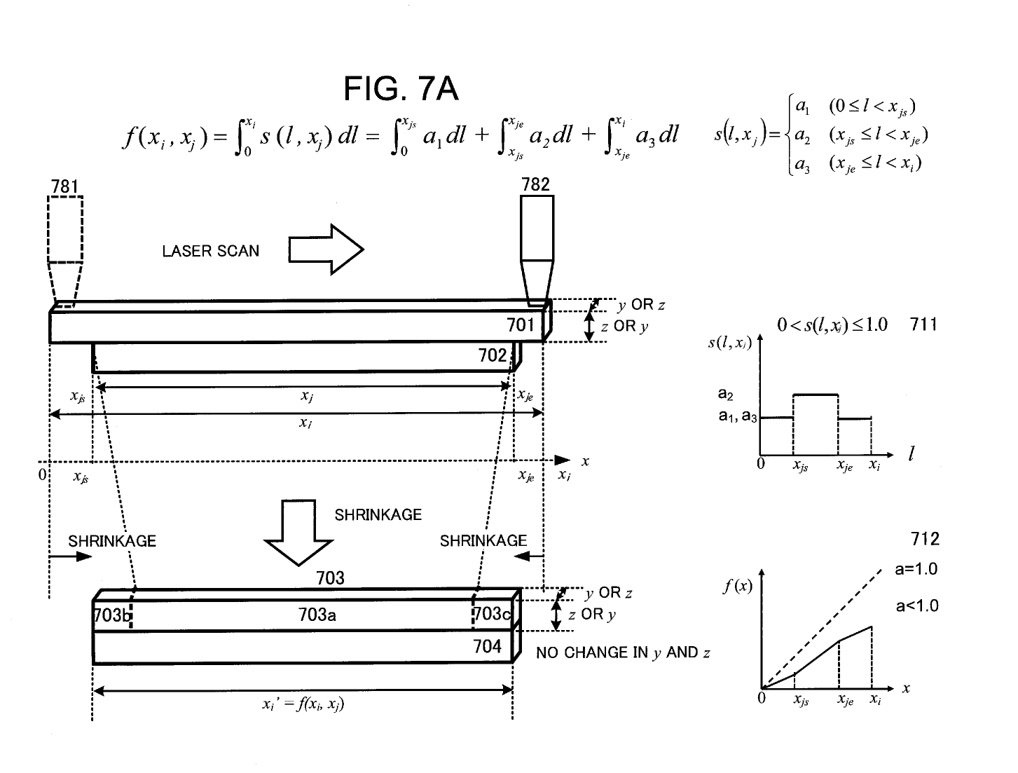

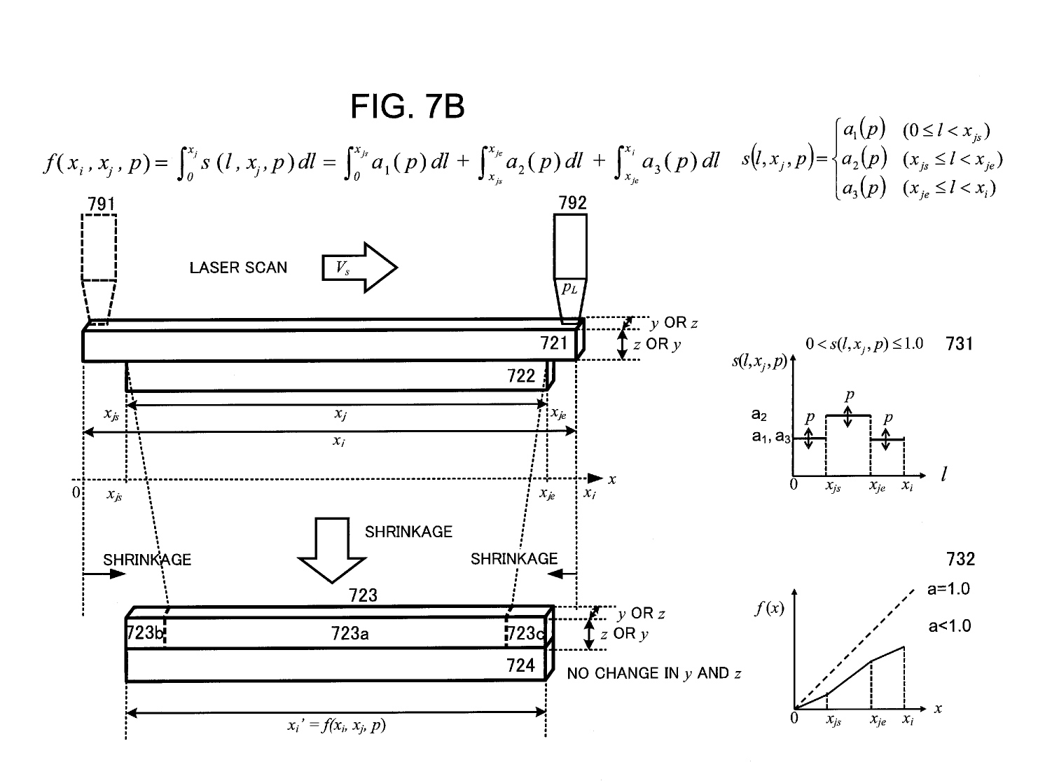

FIG. 7A illustrates a block diagram for modeling the manufacturing process of the three-dimensional structure and formulating the shrinkage of the material for use in the manufacturing process according to an embodiment of the present invention.

It is assumed that the laser scans an area from an end (781) to an end (782) of the scan length xᵢ of the scan path (701) which is a design value with a laser beam. Moreover, it is assumed that there is a shaped object (702), which is directly adjacent to the scan path (701) and which is a part of the three-dimensional structure having already been formed by laser scan. The length of the shaped object (702), which is a part of the three-dimensional structure, has a value xⱼ, and it is assumed that the length is shorter than the scan length xᵢ. It is assumed that the material for use in forming the shaped object which is a part of the three-dimensional structure has shrunk as a result of the laser scan. It is assumed that the length of the shaped object after the shrinkage, which corresponds to the scan length xᵢ and which is a part of the three-dimensional structure formed by the laser scan, has a value xᵢ′ (703; equivalent to 702a+703b+703c). A part (703a) of the shaped object after the laser scan described above has been manufactured by laser-scanning an area where the scan path is directly adjacent to the shaped object (702), a part (703b) of the shaped object has been manufactured by laser-scanning the left area where the scan path is not adjacent to the shaped object (702), and a part (703c) of the shaped object has been manufactured by laser-scanning the right area where the scan path is not adjacent to the shaped object (702). It is assumed that there is no shrinkage of the material in the width (y-axis) direction and in the depth (z-axis) direction associated with the scan length xᵢ or that the shrinkage is within the margin of error. Moreover, the shaped object (702) which is a part of the three-dimensional structure corresponds to a shaped object (704) which is a part of the three-dimensional structure after the shrinkage and does not shrink with the laser scan.

The length xᵢ′ (703) of the shaped object after the shrinkage can be represented by xᵢ′=ƒ(xᵢ, xⱼ), where ƒ(xᵢ, xⱼ) is a shrinkage function and is represented by the following Equation 5. If the above shrinkage depends on the scan length xᵢ and the scan length xⱼ of a neighboring scan path, the computer (101) formulates the shrinkage function as the aforementioned ƒ(xᵢ, xⱼ). The shrinkage function represented by the following Equation 5 can assume that there is an environment affecting the scan path (a shrinkage rate in the case where there is formed a shaped object which is a part of the three-dimensional structure adjacent to the aforementioned scan path and having already been laser-scanned) and that there is no effect of the shaping parameters.

ƒ(x_{ᵢ},x_{ⱼ})=∫₀^{x}_{ᵢ}s(l,x_{ⱼ})dl=∫₀^{x}^{ᵢ}a₁dl+∫ₓ_{ⱼ}^{x}^{ⱼ}a₂dl+∫ₓ_{ⱼ}^{x}^{ᵢ}a₃dl [Equation. 5]

where: xᵢ is the scan length of the scan path; xⱼₛ is the starting point of the shaped object (702) adjacent to the scan path scanned across the scan length xᵢ; xⱼₑ is the end point of the shaped object (702) adjacent to the scan path scanned across the scan length xᵢ; a₁ is a shrinkage rate per unit length of the scan path having a length from the starting point of the scan path scanned across the scan length xᵢ to the point xⱼₛ; a₂ is a shrinkage rate per unit length of the scan path having a length from the point xⱼₛ to the point xⱼₑ; a₃ is a shrinkage rate per unit length of the scan path having a length from the point xⱼₑ to the point xᵢ; and s(l, xⱼ) is a shrinkage rate per unit length of the material and represented by the following Equation 6:

$$s ( l , {x}_{j} ) = \{ \begin{matrix}{a}_{1} & ( 0 \leq l < {x}_{js} ) \\ {a}_{2} & ( {x}_{js} \leq l < {x}_{je} ) \\ {a}_{3} & ( {x}_{je} \leq l < {x}_{i} )\end{matrix} . \qquad [ Equation . 6 ]$$

A graph (711) illustrates that the shrinkage rate includes a₁, a₂, and a₃ (a₁=a₃), and the shrinkage rate is in a range of 0<s(l, xⱼ)≦1.0.

A graph (712) illustrates a relationship between the scan lengths xⱼₛ, xⱼₑ, and xᵢ and the shrinkage function ƒ(xᵢ, xⱼ) in the case of the absence of shrinkage (a=1.0) and in the case of the presence of shrinkage (a<1.0).

FIG. 7B illustrates a block diagram for modeling the manufacturing process of the three-dimensional structure and formulating the shrinkage of the material for use in the manufacturing process according to an embodiment of the present invention.

It is assumed that the laser scans an area from an end (791) to an end (792) of the scan length xᵢ of the scan path (721) which is a design value with a laser beam. Moreover, it is assumed that there is a shaped object (722), which is directly adjacent to the scan path (721) and which is a part of the three-dimensional structure having already been formed by laser scan. The length of the shaped object (722), which is a part of the three-dimensional structure, has a value xⱼ, and the length is assumed to be shorter than the scan length xᵢ. It is assumed that the material for use in forming the shaped object which is a part of the three-dimensional structure has shrunk as a result of the laser scan. It is assumed that the length of the shaped object after the shrinkage, which corresponds to the scan length xᵢ and which is a part of the three-dimensional structure formed by the laser scan, has a value xᵢ′ (723; equivalent to 723a+723b+723c). A part (723a) of the shaped object after the laser scan described above has been manufactured by laser-scanning an area where the scan path is directly adjacent to the shaped object (722), a part (723b) of the shaped object has been manufactured by laser-scanning the left area where the scan path is not adjacent to the shaped object (722), and a part (723c) of the shaped object has been manufactured by laser-scanning the right area where the scan path is not adjacent to the shaped object (722). It is assumed that there is no shrinkage of the material in the width (y-axis) direction and in the depth (z-axis) direction associated with the scan length xᵢ or that the shrinkage is within the margin of error. Moreover, the shaped object (722) which is a part of the three-dimensional structure corresponds to a shaped object (724) which is a part of the three-dimensional structure after the shrinkage and does not shrink with the laser scan.

The length xᵢ′ (723) of the shaped object after the shrinkage can be represented by xᵢ′=ƒ(xᵢ, xⱼ, p), where ƒ(xᵢ, xⱼ, p) is a shrinkage function and is represented by the following Equation 7. If the above shrinkage depends on the scan length xᵢ, the scan length xⱼ of a neighboring scan path, and the shaping parameter, the computer (101) formulates the shrinkage function as the above ƒ(xᵢ, xⱼ, p). The shrinkage function represented by the following Equation 7 can assume that there is an environment affecting the aforementioned scan path (for example, a shrinkage rate in the case where there is formed a shaped object which is a part of the three-dimensional structure adjacent to the aforementioned scan path and having already been laser-scanned) and that there is an effect of the shaping parameters. The above shaping parameters can be, for example, laser power (P_{L}) and laser scan speed (Vₛ).

ƒ(x_{ᵢ}_{,x}_{ⱼ},p)=∫₀^{x}^{ᵢ}s(l,xⱼ,p)dl=∫₀^{x}^{ⱼ}a₁(p)dl+∫ₓ_{ⱼ}^{x}^{ⱼ}a₂(p)dl+∫ₓ_{ⱼ}^{x}^{ⱼ}a₃(p)dl [Equation. 7]

where: xᵢ is the scan length of the scan path; xⱼₛ is the starting point of the shaped object (722) adjacent to the scan path scanned across the scan length xᵢ; xⱼₑ is the end point of the shaped object (722) adjacent to the scan path scanned across the scan length xᵢ; p is a shaping parameter of the aforementioned manufacturing process; a₁ is a shrinkage rate per unit length of the scan path, which fluctuates with the shaping parameter, having a length from the starting point of the scan path scanned across the scan length xᵢ to the point xⱼₛ; a₂ is a shrinkage rate per unit length of the scan path, which fluctuates with the shaping parameter, having a length from the point xⱼₛ to the point xⱼₑ; a₃ is a shrinkage rate per unit length of the scan path, which fluctuates with the shaping parameter, having a length from the point xⱼₑ to the point xᵢ; and s(l, xⱼ, p) is a shrinkage rate per unit length of the material and represented by the following Equation 8:

$$s ( l , {x}_{j} , p ) = \{ \begin{matrix}{a}_{1} ( p ) & ( 0 \leq l < \text{?} ) \\ {a}_{2} ( p ) & ( \text{?} \leq l < {x}_{je} ) \\ {a}_{3} ( p ) & ( {x}_{je} \leq l < {x}_{i} )\end{matrix} \\ \text{?} \text{indicates text missing or illegible when filed} \qquad [ Equation . 8 ]$$

A graph (731) illustrates that the shrinkage rate includes a₁, a₂, and a₃ (a₁=a₃), though fluctuating with the shaping parameter p, and the shrinkage rate is in a range of 0<s(l, xⱼ, p)≦1.0.

A graph (732) illustrates a relationship between the scan lengths xⱼₛ, xⱼₑ, and xᵢ and the shrinkage function ƒ(xᵢ, xⱼ, p) in the case of the absence of shrinkage (a=1.0) and in the case of the presence of shrinkage (a<1.0).

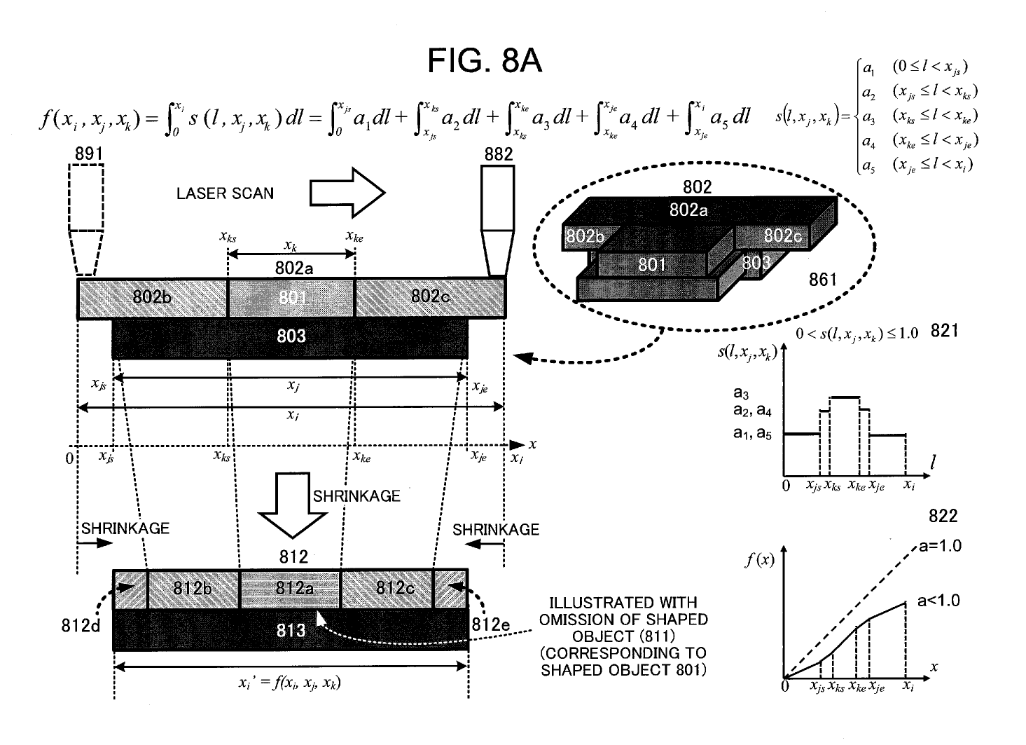

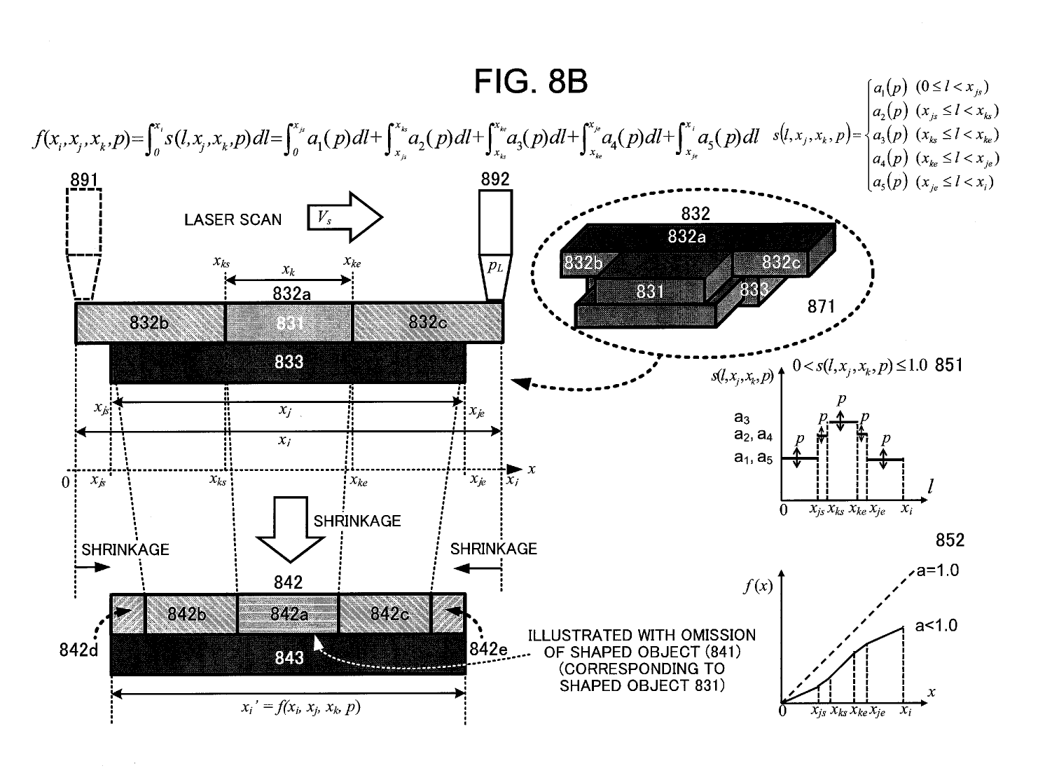

FIG. 8A illustrates a block diagram for modeling the manufacturing process of the three-dimensional structure and formulating the shrinkage of the material for use in the manufacturing process according to an embodiment of the present invention.

The three-dimensional structure (861) represents a structure which is expected to be manufactured based on scan path data represented by a design drawing.

It is assumed that the laser scans an area from an end (881) to an end (882) of the scan length xᵢ of the scan path (802) which is a design value with a laser beam. Moreover, it is assumed that there is a first shaped object (801), which is directly adjacent to the lateral side of the scan path (802) and which is a part of the three-dimensional structure having already been formed by laser scan, and further there is a second shaped object (803), which is directly adjacent to the underside of the scan path (802) and which is a part of the three-dimensional structure having already been formed by laser scan. The length of the first shaped object (801), which is a part of the three-dimensional structure, has a value xₖ (shorter than the scan length xᵢ and the length xⱼ of the second shaped object [803]) and the length of the second shaped object (803), which is a part of the three-dimensional structure, has a value xⱼ (shorter than the scan length xᵢ). It is assumed that the material for use in forming the shaped object which is a part of the three-dimensional structure has shrunk as a result of the laser scan. It is assumed that the length of the shaped object after the shrinkage, which corresponds to the scan length xᵢ and which is a part of the three-dimensional structure formed by the laser scan, has a value xᵢ′ (812; equivalent to 812a+812b+812c+812d+812e).

A part (812a) of the shaped object after the laser scan described above has been manufactured by laser-scanning an area (802a) where the scan path is directly adjacent to the shaped object (801), a part (812b) of the shaped object has been manufactured by laser-scanning the left area where the scan path is directly adjacent to the shaped object (803) (except an area directly adjacent to the shaped object [801]), a part (812c) of the shaped object has been manufactured by laser-scanning the right area where the scan path is directly adjacent to the shaped object (803) (except an area directly adjacent to the shaped object [801]), a part (812d) of the shaped object has been manufactured by laser-scanning the left area where the scan path is not directly adjacent to the shaped object (803), and a part (812e) of the shaped object has been manufactured by laser-scanning a part of the right area where the scan path is not directly adjacent to the shaped object (803). It is assumed that there is no shrinkage of the material in the width (y-axis) direction and in the depth (z-axis) direction associated with the scan length xᵢ or that the shrinkage is within the margin of error. Moreover, the first shaped object (801), which is a part of the three-dimensional structure, corresponds to the first shaped object (811) which is a part of the three-dimensional structure after the shrinkage and does not shrink with the laser scan. Similarly, the second shaped object (803), which is a part of the three-dimensional structure, corresponds to the second shaped object (813) which is a part of the three-dimensional structure after the shrinkage and does not shrink with the laser scan.

The length xᵢ′ (812) of the shaped object after the shrinkage can be represented by xᵢ′=ƒ(xᵢ, xⱼ, xₖ), where ƒ(xᵢ, xⱼ, xₖ) is a shrinkage function and is represented by the following Equation 9. If the above shrinkage depends on the scan length xᵢ, the scan lengths xⱼ and xₖ of neighboring scan paths, the computer (101) formulates the shrinkage function as the above ƒ(xᵢ, xⱼ, xₖ). The shrinkage function represented by the following Equation 9 can assume that there is an environment affecting the aforementioned scan path (a shrinkage rate in the case where there is formed a shaped object which is a part of the three-dimensional structure adjacent to the aforementioned scan path and having already been laser-scanned) and that there is no effect of the shaping parameters.

ƒ(x_{ⱼ}_{,x}_{ⱼ}_{,x}_{ⱼ})=∫₀^{x}^{ᵢ}s(l,x_{_{j,}}ₓ_{ⱼ})dl=∫₀^{x}^{ᵢ}a₁dl+∫ₓ_{ⱼ}^{x}^{ᵢ}a₂dl+∫ₓ_{ⱼ}^{x}^{ᵢ}a₃dl+∫ₓ_{ⱼₛ}^{x}^{ᵢ}a₄dl+∫ₓ_{ⱼ}^{x}^{ᵢ}a₅dl [Equation. 9]

where: xᵢ is the scan length of the scan path; xⱼₛ is the starting point of a first shaped object (801) adjacent to the scan path scanned across the scan length xᵢ; xⱼₑ is the end point of the first shaped object (801) adjacent to the scan path scanned across the scan length xᵢ; xₖₛ is the starting point of a second shaped object (803) adjacent to the scan path scanned across the scan length xᵢ, and the starting point of the second shaped object (803) exists between the starting point of the first shaped object (801) and the end point of the first shaped object (801); xₖₑ is the end point of the second shaped object (803) adjacent to the scan path scanned across the scan length xᵢ, and the end point of the second shaped object (803) exists between the starting point of the first shaped object (801) and the end point of the first shaped object (801); a₁ is a shrinkage rate per unit length of the scan path having a length from the starting point of the scan path scanned across the scan length xᵢ to the point xⱼₛ; a₂ is a shrinkage rate per unit length of the scan path having a length from the point xⱼₛ to the point xₖₛ; a₃ is a shrinkage rate per unit length of the scan path having a length from the point xₖₛ to the point xₖₑ; a₄ is a shrinkage rate per unit length of the scan path having a length from the point xₖₑ to the point xⱼₑ; a₅ is a shrinkage rate per unit length of the scan path having a length from the point xⱼₑ to the xᵢ; and s(l, xⱼ, xₖ) is a shrinkage rate per unit length of the material and represented by the following Equation 10:

$$s ( l , {x}_{j} , {x}_{k} ) = \{ \begin{matrix}{a}_{1} & ( 0 \leq l < {x}_{js} ) \\ {a}_{2} & ( {x}_{js} \leq l < \text{?} ) \\ {a}_{3} & ( \text{?} \leq l < \text{?} ) \\ {a}_{4} & ( \text{?} \leq l < {x}_{je} ) \\ {a}_{5} & ( \text{?} \leq l < {x}_{i} )\end{matrix} \\ \text{?} \text{indicates text missing or illegible when filed} \qquad [ Equation . 10 ]$$

A graph (821) illustrates that the shrinkage rate includes a1, a2, a3, a4, and a5 (a1=a5, a2=a4), and the shrinkage rate is in a range of 0<s(l, xj, xk)≦1.0.

A graph (822) illustrates a relationship between the scan lengths xⱼₛ, xⱼₑ, xₖₛ, xₖₑ, and xᵢ and the shrinkage function ƒ(xᵢ, xⱼ, xₖ) in the case of the absence of shrinkage (a=1.0) and in the case of the presence of shrinkage (a<1.0).

FIG. 8B illustrates a block diagram for modeling the manufacturing process of the three-dimensional structure and formulating the shrinkage of the material for use in the manufacturing process according to an embodiment of the present invention.

The three-dimensional structure (871) represents a structure which is expected to be manufactured based on scan path data represented by a design drawing.

It is assumed that the laser scans an area from an end (891) to an end (892) of the scan length xᵢ of the scan path (832) which is a design value with a laser beam. Moreover, it is assumed that there is a first shaped object (831), which is directly adjacent to the lateral side of the scan path (832) and which is a part of the three-dimensional structure having already been formed by laser scan, and further there is a second shaped object (833), which is directly adjacent to the underside of the scan path (832) and which is a part of the three-dimensional structure having already been formed by laser scan. The length of the first shaped object (831), which is a part of the three-dimensional structure, has a value xₖ (shorter than the scan length xᵢ and the length xⱼ of the second shaped object [833]) and the length of the second shaped object (833), which is a part of the three-dimensional structure, has a value xⱼ (shorter than the scan length xᵢ). It is assumed that the material for use in forming the shaped object which is a part of the three-dimensional structure has shrunk as a result of the laser scan. It is assumed that the length of the shaped object after the shrinkage, which corresponds to the scan length xᵢ and which is a part of the three-dimensional structure formed by the laser scan, has a value xᵢ′ (842; equivalent to 842a+842b+842c+842d+842e).

A part (842a) of the shaped object after the laser scan described above has been manufactured by laser-scanning an area (832a) where the scan path is directly adjacent to the shaped object (831), a part (842b) of the shaped object has been manufactured by laser-scanning the left area where the scan path is directly adjacent to the shaped object (833) (except an area directly adjacent to the shaped object [831]), a part (842c) of the shaped object has been manufactured by laser-scanning the right area where the scan path is directly adjacent to the shaped object (833) (except an area directly adjacent to the shaped object [831]), a part (842d) of the shaped object has been manufactured by laser-scanning the left area where the scan path is not directly adjacent to the shaped object (833), and a part (842e) of the shaped object has been manufactured by laser-scanning a part of the right area where the scan path is not directly adjacent to the shaped object (833). It is assumed that there is no shrinkage of the material in the width (y-axis) direction and in the depth (z-axis) direction associated with the scan length xᵢ or that the shrinkage is within the margin of error. Moreover, the first shaped object (831), which is a part of the three-dimensional structure, corresponds to the first shaped object (841) which is a part of the three-dimensional structure after the shrinkage and does not shrink with the laser scan. Similarly, the second shaped object (833), which is a part of the three-dimensional structure, corresponds to the second shaped object (843) which is a part of the three-dimensional structure after the shrinkage and does not shrink with the laser scan.

The length xᵢ′ (842) of the shaped object after the shrinkage can be represented by xᵢ′=ƒ(xᵢ, xⱼ, xₖ, p), where ƒ(xᵢ, xⱼ, xₖ, p) is a shrinkage function and is represented by the following Equation 11. If the above shrinkage depends on the scan length xᵢ, the scan lengths xⱼ and xₖ of neighboring scan paths, and shaping parameters, the computer (101) formulates the shrinkage function as ƒ(xᵢ, xⱼ, xₖ, p). The shrinkage function represented by the following Equation 11 can assume that there is an environment affecting the aforementioned scan path (a shrinkage rate in the case where there is formed a shaped object which is a part of the three-dimensional structure adjacent to the aforementioned scan path and having already been laser-scanned) and that there is an effect of the shaping parameters. The shaping parameters can be, for example, laser power (P_{L}) and laser scan speed (Vₛ).

ƒ(xᵢ,xⱼ,xₖ,p)=∫₀^{x}^{ᵢ}s(l,xᵢ,xₖ,p)dl=∫₀^{x}^{ᵢ}a₃(p)dl+∫ₓ_{ⱼ}^{x}^{ᵢ}a₂(p)dl+∫a₃(p)dl+∫ₓ_{ⱼ}^{x}^{ᵢ}a₄(p)dl+∫ₓ_{ⱼ}^{x}^{ᵢ}a₅(p)dl [Equation. 11]

where: xᵢ is the scan length of the scan path; xⱼₛ is the starting point of the first shaped object (831) adjacent to the scan path scanned across the scan length xᵢ; xⱼₑ is the end point of the first shaped object (831) adjacent to the scan path scanned across the scan length xᵢ; xₖₛ is the starting point of the second shaped object (833) adjacent to the scan path scanned across the scan length xᵢ, and the starting point of the second shaped object exists between the starting point of the first shaped object (831) and the end point of the first shaped object (831); xₖₑ is the end point of the second shaped object (833) adjacent to the scan path scanned across the scan length xᵢ, and the end point of the second shaped object (833) exists between the starting point of the first shaped object (831) and the end point of the first shaped object (831); p is a shaping parameter of the aforementioned manufacturing process; a₁ is a shrinkage rate per unit length of the scan path, which fluctuates with the shaping parameter, having a length from the starting point of the scan path scanned across the scan length xᵢ to the point xⱼₛ; a₂ is a shrinkage rate per unit length of the scan path, which fluctuates with the shaping parameter, having a length from the point xⱼₛ to the point xₖₛ; a₃ is a shrinkage rate per unit length of the scan path, which fluctuates with the shaping parameter, having a length from the point xₖₛ to the point xₖₑ; a₄ is a shrinkage rate per unit length of the scan path, which fluctuates with the shaping parameter, having a length from the point xₖₑ to the point xⱼₑ; a₅ is a shrinkage rate per unit length of the scan path, which fluctuates with the shaping parameter, having a length from the point xⱼₑ to the point xᵢ; and s(l, xⱼ, xₖ, p) is a shrinkage rate per unit length of the aforementioned material and represented by the following Equation 12:

$$s ( l , {x}_{j} , {x}_{k} , p ) = \{ \begin{matrix}{a}_{1} ( p ) & ( 0 \leq l < {x}_{js} ) \\ {a}_{2} ( p ) & ( {x}_{js} \leq l < \text{?} ) \\ {a}_{3} ( p ) & ( \text{?} \leq l < \text{?} ) \\ {a}_{4} ( p ) & ( \text{?} \leq l < {x}_{je} ) \\ {a}_{5} ( p ) & ( {x}_{je} \leq l < {x}_{i} )\end{matrix} . \\ \text{?} \text{indicates text missing or illegible when filed} \qquad [ Equation . 12 ] .$$

A graph (851) illustrates that the aforementioned shrinkage rate includes a₁, a₂, a₃, a₄, and a₅ (a₁=a₅, a₂=a₄) though fluctuating with the shaping parameter p, and the shrinkage rate is in a range of 0<s(l, xⱼ, xₖ, p)≦1.0.

A graph (852) illustrates a relationship between the scan lengths xⱼₛ, xⱼₑ, xₖₛ, xₖₑ, and xᵢ and the shrinkage function ƒ(xᵢ, xⱼ, xₖ, p) in the case of the absence of shrinkage (a=1.0) and in the case of the presence of shrinkage (a<1.0).

FIG. 9 illustrates two examples of a block diagram for formulating the shrinkage in response to a break of the material caused by the shrinkage of the material when the scan path is irradiated with laser according to an embodiment of the present invention.

FIG. 9 Example A illustrates that the shrinkage is formulated as a shrinkage function with a constraint condition of a length in response to the break of the material caused by the shrinkage of the material when the scan path is irradiated with laser.

It is assumed that the laser scans an area with a laser beam from an end to an end of the scan length x of the scan path (901) which is a design value. Since the scan length x is long, in some cases a shaped object breaks due to shrinkage caused by the laser radiation (903-1, 903-2, and 903-3). Whether the scan length x is long can also depend on, for example, a photo-curable resin which is the material. The length of the shaped object generated by the break is not necessarily uniform. For example, the length can be nonuniform due to an influence of at least one shaped object adjacent to the scan path. The occurrence of the break makes it difficult to formulate the shrinkage.

Therefore, the computer (101) can obtain the constraint condition of a length in such a way that the scan length x does not exceed the length (xₘₐₓ) at which the break occurs due to the shrinkage of the material. Additionally, the computer (101) can formulate the shrinkage function with the constraint condition of the length in formulating the shrinkage.

FIG. 9 Example B illustrates that the scan path is divided into a plurality of paths in response to a break of the material caused by the shrinkage of the material when the scan path is irradiated with laser and then the shrinkage for each divided path is formulated as a shrinkage function.

As has been described in FIG. 9 Example A, for example, it is assumed that the laser scans an area with a laser beam from an end to an end of the scan length xᵢ of the scan path (901) which is a design value. Since the scan length xᵢ is long, in some cases a shaped object breaks due to shrinkage caused by the laser radiation (903-1, 903-2, and 903-3). In the case where it is expected that this kind of break occurs, the computer (101) can divide the scan path obtained from the design drawing into a plurality of scan paths (for example, scan path 1, scan path 2, and scan path 3) within a range where the break does not occur and formulate the shrinkage as a plurality of shrinkage functions.

FIG. 10 illustrates the Beer-Lambert law and a laser beam scanning model for describing that the optimization calculation is performed conforming to a constraint condition of the thickness of a surplus growth according to an embodiment of the present invention.

In the following, the description of the optimization calculation which is performed conforming to the constraint condition of the thickness of a surplus growth is based on the description in “Theoretical Analysis and Experimental Evaluation on Solidified parts’ Surplus Growth in Stereo-lithography” by Akiya Kamimura et al. “Theoretical Analysis and Experimental Evaluation on Solidified parts' Surplus Growth in Stereo-lithography” by Akiya Kamimura et al. is hereby incorporated herein by reference.

In the case where the manufacturing process of the three-dimensional structure is performed in the stereolithography, a photopolymerization reaction does not occur in a photo-curable resin at a predetermined exposure amount (in other words, the critical exposure amount Ec) or less. This is because predetermined energy is consumed in order to consume oxygen contained in the photo-curable resin.

In the case of performing exposure by irradiating the aforementioned photo-curable resin surface with laser, an exposure amount at a certain depth under the exposed surface conforms to the Beer-Lambert law (see FIG. 10 Diagram A [1001]). In the Beer-Lambert law, the exposure amount E(z) at the depth on the exposed surface is represented by the following Equation 14:

$$E ( z ) = E exp ( - \frac{z}{{D}_{p}} ) \qquad [ Equation . 14 ]$$

where E(z) is an exposure amount; E is an exposure amount (mJ/cm²) on the exposed surface; z is a depth (μm) on the exposed surface; and Dₚ is a penetration depth (μm).

As illustrated in FIG. 10 Diagram A, the penetration depth Dₚ means a depth at which the exposure amount reaches 1/e of the irradiance level on the exposed surface. As the material characteristic parameters of the photo-curable resin, particularly the critical exposure amount E_{C} and the penetration depth Dₚ are important.

As illustrated in the laser beam scanning model (1011) of FIG. 10 Diagram B, the exposure amount distribution for a single curing line is calculated according to the following Equation 15 on the yz cross section in the position of a certain x, assuming that the laser scanning direction is the x-axis positive direction, the depth direction is the z-axis positive direction, and the exposed surface exists at the z origin. The Equation 15 is also used to obtain an exposure amount distribution in the yz plane in the case of scanning with a Gaussian-shaped beam having a three-dimensional distribution in the x-axis direction at constant speed and constant power.

$$E ( y , z ) = {E}_{max} exp \{ - 2 {( \frac{y}{{W}_{0}} )}^{2} \} exp ( - \frac{z}{{D}_{p}} ) \\ {E}_{max} = \sqrt{\frac{2}{π}} ( \frac{{P}_{L}}{{W}_{0} {V}_{s}} ) \qquad [ Equation 15 ]$$

where: W₀ is a laser beam radius (μm); P_{L} is laser power (mW); and Vₛ is laser scan speed (cm/s).

The curing of the photo-curable resin occurs at a critical exposure amount E_{c} or more. Therefore, a curing boundary in the yz plane (an inverted bell shape illustrated in FIG. 10 Diagram B) is obtained by solving an equation, E(y, z)=E_{c}.

Subsequently, the exposure amount distribution on the cured layer in the case where the curing lines are overlapped at a certain hatch spacing hs (μm) is calculated according to the following Equation 16 obtained by replacing y in the aforementioned Equation 15 by y-mhs:

$$E ( y , z ) = {E}_{max} exp \{ - 2 {( \frac{y - m \text{?}}{{W}_{0}} )}^{2} \} exp ( - \frac{z}{{D}_{p}} ) \\ \text{?} \text{indicates text missing or illegible when filed} \qquad [ Equation . 16 ]$$

In the Equation 16, the value of an integer m (the number of scanning times) indicates the exposure amount distribution of the curing line in each position. Therefore, the exposure amount distribution of the entire cured layer is calculated according to the following Equation 17 by using the principle of adding exposure amounts:

$$E ( y , z ) = \text{?} {E}_{max} exp \{ - 2 {( \frac{y - m \text{?}}{{W}_{0}} )}^{2} \} exp ( - \frac{z}{{D}_{p}} ) \\ \text{?} \text{indicates text missing or illegible when filed} \qquad [ Equation . 17 ]$$

Subsequently, the exposure amount distribution in the yz plane, in the case where a photo-curable resin is supplied and cured with a certain layer thickness L_{T} (μm) on the cured layer and then the curing is repeated, is calculated according to the following Equations 18 and 19:

$$E ( y , z ) = \text{?} \text{?} {E}_{max} exp \{ - 2 {( \frac{y - m \text{?}}{{W}_{0}} )}^{2} \} exp ( - \frac{z - ( n - 1 ) {L}_{T}}{{D}_{p}} ) . \\ \text{?} \text{indicates text missing or illegible when filed} \qquad [ Equation . 18 ]$$

In the above, the inequality 0≦k−1≦z/L_{T}≦k≦l (first layer) is satisfied, where n is the number of layers.

$$E ( y , z ) = \text{?} \text{?} {E}_{max} exp \{ - 2 {( \frac{y - m \text{?}}{{W}_{0}} )}^{2} \} exp ( - \frac{z - ( n - 1 ) {L}_{T}}{{D}_{p}} ) . \\ \text{?} \text{indicates text missing or illegible when filed} \qquad [ Equation . 19 ]$$

In the above, the inequality l (first layer)≦z/L_{T} is satisfied, where n is the number of layers and l is the total number of layers.

Also in the calculation of the exposure distribution in the case of stacking cured layers, the cured shape is obtained by solving the equation E(y, z)=Ec. Moreover, the maximum curing depth is acquired by obtaining z satisfying E(0, z)=Ec. Therefore, the thickness of the surplus growth Δs (μm) is obtained by solving E(0, zₘₐₓ)=E_{c} in the Equation 19 and calculating Δs=zₘₐₓ−l (first layer).

As described above, the computer (101) is able to perform the optimization calculation according to the constraint condition of the thickness of the surplus growth.

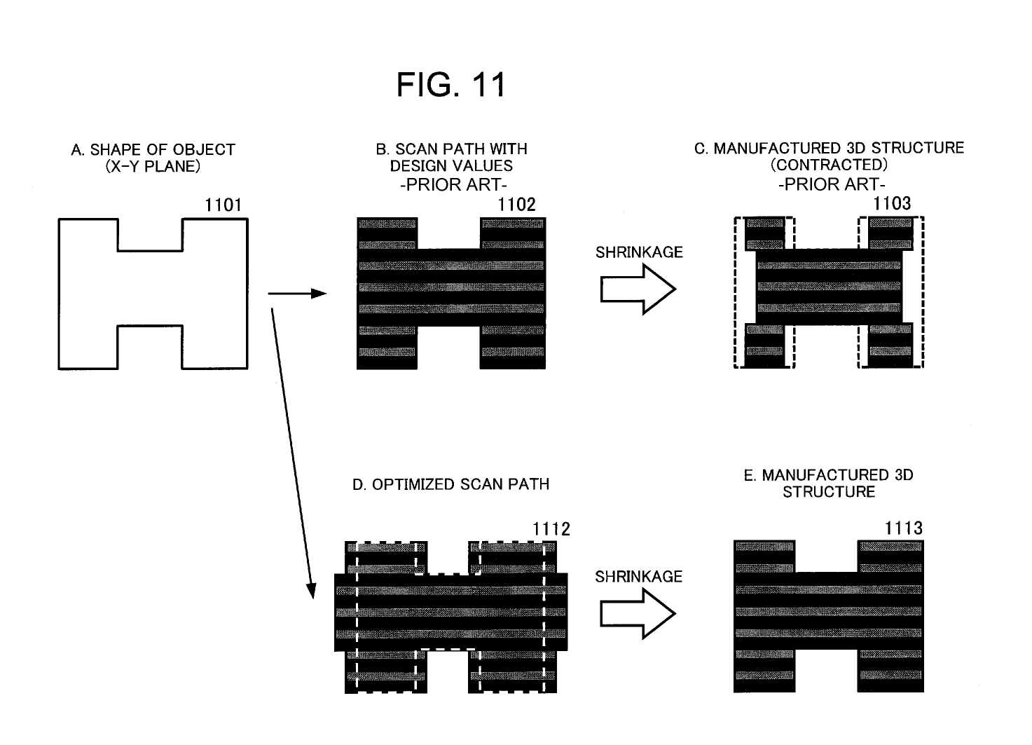

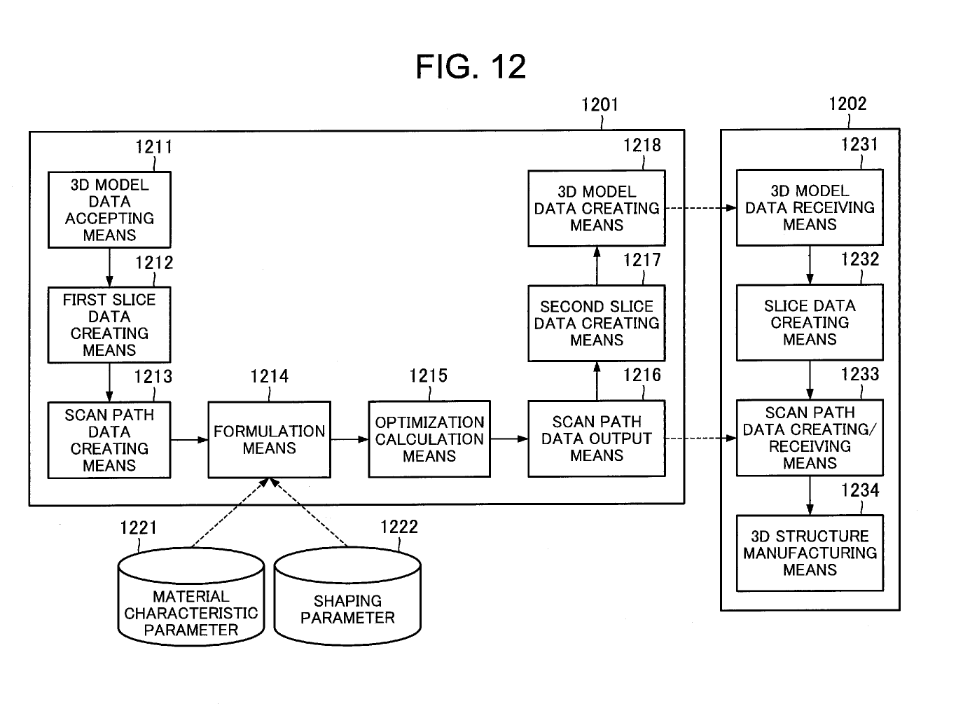

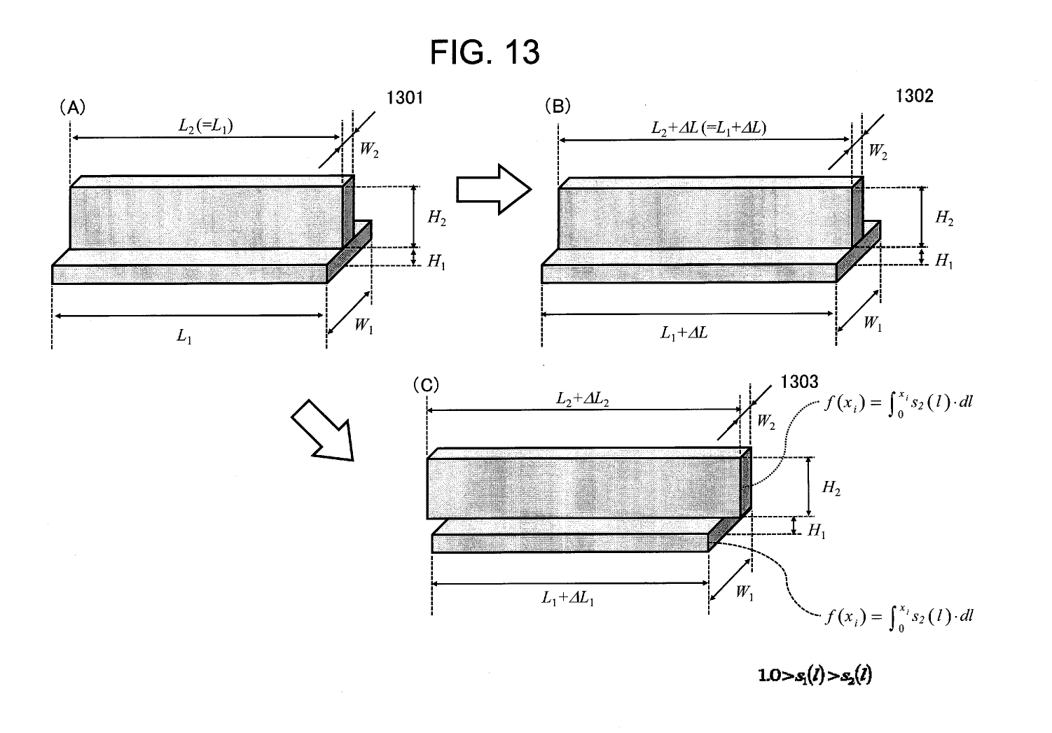

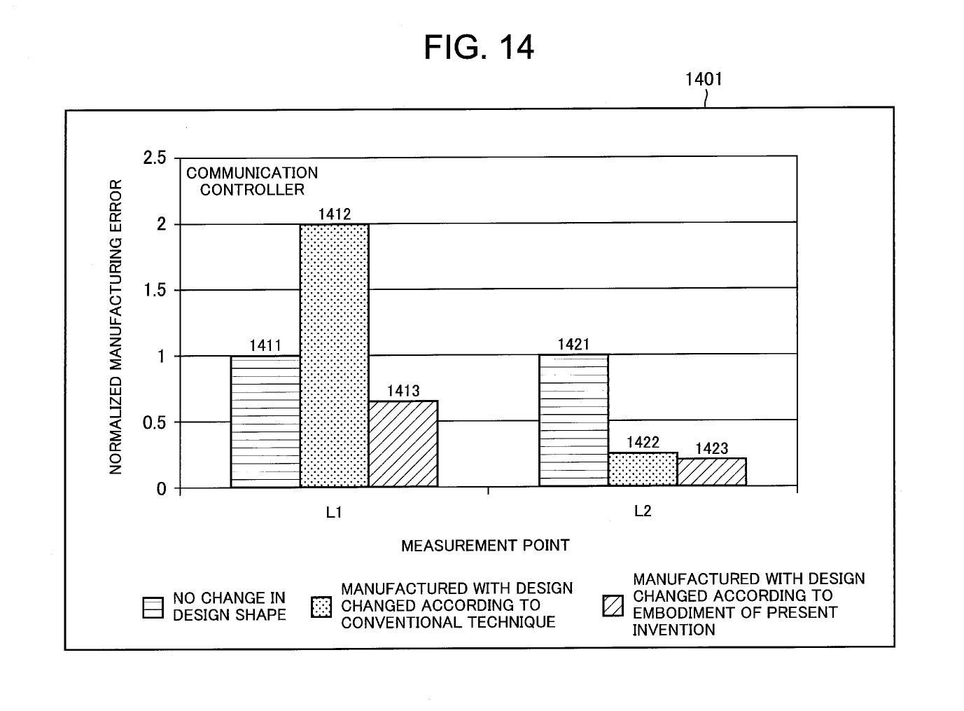

FIG. 11 is a diagram illustrating a three-dimensional structure manufactured using a conventional technique and a three-dimensional structure manufactured according to an embodiment of the present invention.

Model shape A (illustrated only in the X-Y plane) (1101), or FIG. 11 Step A, is a shape into which the three-dimensional structure is intended to be manufactured. The shape A is illustrated only in the X-Y plane.

Model shape B (1102), or FIG. 11 Step B, represents a design value of an expected scan path, which has been provided from STL data for manufacturing the shape A according to the conventional art. The design value of the expected scan path coincides with the model shape A (the dotted-line region).

Model shape C (1103), or FIG. 11 Step C, represents a shape of the three-dimensional structure (the shape only in the X-Y plane is illustrated) which has been manufactured by using a three-dimensional structure manufacturing machine based on the design value of the scan path. The shape C (1103) is smaller than the model shape A (dotted-line region) due to the shrinkage of the material.

Model shape D (1112), or FIG. 11 Step D, represents a design value of a scan path provided by performing an optimization calculation for minimizing a difference between the dimensions of the three-dimensional structure after the shrinkage of the material and the design values by using a shrinkage model formulated according to an embodiment of the present invention and computing the scan length minimizing the difference. The design value of the scan path provided according to an embodiment of the present invention gives a shape larger than the model shape A (dotted-line region). Note, however, that the enlargement factor depends on the scan path.

Model shape E (1113), or FIG. 11 Step E, represents a shape of the three-dimensional structure (the shape only in the X-Y plane is illustrated) which has been manufactured by using a three-dimensional structure manufacturing machine based on the design value of the scan path provided according to an embodiment of the present invention. The shape E (1113) coincides with the model shape A (1101).

Therefore, a shape distortion caused by heat shrinkage is minimized in the shape of the three-dimensional structure which has been manufactured based on the design value of the scan path provided according to an embodiment of the present invention.

The three-dimensional structure is manufactured based on the design value of the scan path provided according to an embodiment of the present invention as described above, by which the constraints imposed to reduce the shrinkage rate in the material design are eased, which enables material design with higher degree of freedom. Therefore, the present invention enables material design for minimizing the sacrifice in the strength and heat resistance of the three-dimensional structure.

FIG. 12 is a diagram illustrating an example of a functional block diagram of a computer preferably having a hardware configuration illustrated in FIG. 1 and according to an embodiment of the present invention.

A computer (1201) includes three-dimensional model data accepting means (1211), first slice data providing means (1212), scan path data providing means (1213), formulation means (1214), optimization calculation means (1215), and scan path data output means (1216), and arbitrarily, second slice data providing means (1217), and three-dimensional model data providing means (1218).

The three-dimensional model data accepting means (1211) accepts and stores three-dimensional model data into a recording medium which, for example, the computer (1201) is able to access.

The three-dimensional model data accepting means (1211) can perform step 302 illustrated in FIG. 3.

The first slice data providing means (1212) provides slice data from the three-dimensional model data accepted by the three-dimensional model data accepting means (1211).

The first slice data providing means (1212) can perform step 303 illustrated in FIG. 3.

The scan path data providing means (1213) provides scan path data Xᵢ from the slice data provided by the first slice data providing means (1212). The scan path data providing means (1213) can perform step 304 illustrated in FIG. 3.

The formulation means (1214) models the manufacturing process of the three-dimensional structure and formulates the shrinkage of the material for use in the manufacturing process by using a material characteristic parameter (1221), a shaping parameter (1222), or the combination thereof. The formulation means (1214) can perform step 305 illustrated in FIG. 3.

The optimization calculation means (1215) performs an optimization calculation for minimizing a difference between the dimensions of the three-dimensional structure after the shrinkage of the material and the design values by using a shrinkage model formulated by the formulation means (1214) and computes the scan length x for minimizing the difference. The optimization calculation means (1215) can perform step 306 illustrated in FIG. 3.

The scan path data output means (1216) outputs scan path data including the scan length x calculated by the optimization calculation means (1215).

The scan path data output means (1216) can perform steps 307 and 308 illustrated in FIG. 3.

The second slice data providing means (1217) provides slice data optimized from the scan path data xᵢ including the scan length x output from the scan path data output means (1216). The second slice data providing means (1217) can perform step 309 illustrated in FIG. 3.

The three-dimensional model data providing means (1218) provides optimized three-dimensional model data from the optimized slice data provided by the second slice data providing means (1217). The three-dimensional model data providing means (1218) can perform step 310 illustrated in FIG. 3.

The computer (1201) is connected to the three-dimensional structure manufacturing machine (1201) via a wired or wireless connection or mounted in the three-dimensional structure manufacturing machine in a non-detachable way.

The three-dimensional structure manufacturing machine (1201) includes scan path data providing/receiving means (1233) and three-dimensional structure manufacturing means (1234) and further can arbitrarily include three-dimensional model data receiving means (1231) and slice data providing means (1232).

The three-dimensional model data receiving means (1231) receives the optimized slice data, which has been provided by the three-dimensional model data providing means (1218) included in the computer (1201), from the computer (1201).

The slice data providing means (1232) provides slice data from the optimized slice data which has been received by the three-dimensional model data receiving means (1231).

The scan path data providing/receiving means (1233) provides scan path data from the slice data provided by the slice data providing means (1232). Alternatively, the scan path data providing/receiving means (1233) receives scan path data output from the scan path data output means (1216) included in the computer (1201).

The three-dimensional structure manufacturing means (1234) manufactures a three-dimensional structure on the basis of the scan path data from the scan path data providing/receiving means (1233). The three-dimensional structure can be a three-dimensional structure manufactured using the stereolithography or a three-dimensional structure manufactured using the selective laser sintering method.

The three-dimensional structure manufacturing means (1234) can include various means for performing a process in the stereolithography or various means for performing a process in the selective laser sintering method.

### Practical Example

With a three-dimensional shape illustrated in FIG. 13 Diagram A as a target shape, a three-dimensional structure was manufactured by actually using a 3D printer and a manufacturing error of the three-dimensional structure was measured.

The targeted three-dimensional shape is a shape in which a rectangular parallelepiped shape having a length L₁, a width W₁, and a height H₁ is combined with a rectangular parallelepiped shape having a length L₂, a width W₂, and a height H₂ so that an inverted T-shape is formed. Note, however, that L₁=L₂. The aspect ratios (=height/width) of the respective rectangular parallelepiped shapes are H₁/W₁=0.33 and H₂/W₂=3.

FIG. 13 Diagram B illustrates a three-dimensional shape in which the scan length was uniformly changed in anticipation of a shrinkage of the material according to the conventional technique in the case where the three-dimensional shape illustrated in FIG. 13(A) is determined to be a target shape. Specifically, the scan length corresponding to the length L₁ of the target shape illustrated in FIG. 13 Diagram A was changed to L₁+ΔL and the length L₂ of the target shape illustrated in FIG. 13 Diagram A was changed to L₂+ΔL.

FIG. 13 Diagram C illustrates a three-dimensional shape with a design changed by performing an optimization calculation for minimizing a difference between the dimensions of the three-dimensional structure after the shrinkage of the material and the design values by using a formulated shrinkage model and computing a scan length minimizing the difference according to an embodiment of the present invention, in the case where the three-dimensional shape is determined to be a target shape illustrated in FIG. 13 Diagram A similarly to the case illustrated in FIG. 13 Diagram B. With the shrinkage rate of the material as s(l), different shrinkage rates s₁(l) and s₂(l) have been used for the rectangular parallelepiped shape having the length L₁, the width W₁, and the height H₁ and the rectangular parallelepiped shape having the length L₂, the width W₂, and the height H₂ (1.0>s₁(l)>s₂(l)), respectively. Therefore, the scan length corresponding to the length L₁ of the target shape illustrated in FIG. 13 Diagram A and the length L₂ of the target shape illustrated in FIG. 13 Diagram A were changed to L₁+ΔL₁ and L₂+ΔL₂ (ΔL₁<ΔL₂), respectively.

Three types of three-dimensional structures described below were manufactured by using a 3D printer on the basis of the above. In manufacturing the three types of three-dimensional structures, it is assumed that the manufacturing conditions other than the design shape and the type of resin are common to these three-dimensional structures.

For the first type, the three-dimensional structure was manufactured without change in the design shape directly by using the target shape illustrated in FIG. 13 Diagram A.

For the second type, the three-dimensional structure was manufactured with the design shape changed uniformly (specifically, independently of the places [two rectangular parallelepiped shapes]) in anticipation of a shrinkage of the material according to the conventional technique, as illustrated in FIG. 13 Diagram B.

For the third type, the three-dimensional structure was manufactured with the design shape changed so as to be dependent on the places (two rectangular parallelepiped shapes) according to an embodiment of the present invention, as illustrated in FIG. 13 Diagram C.

Five of each of the above three types of three-dimensional shapes were manufactured and the lengths were measured in two places, L₁ and L₂.

Differences from the target shape were computed from the measurement results and averages thereof were determined to be manufacturing errors. Additionally, with a manufacturing error in the case where the target shape is used directly as a design shape (the first type in the above) as 1, manufacturing errors in the case of change in design shape (the second and third types in the above) were normalized.

FIG. 14 illustrates the normalized manufacturing errors. In the case where the design shape is changed according to the conventional technique as illustrated in FIG. 13 Diagram B (1412, 1422), the manufacturing error of L₂ (1422) was decreased in comparison with the case of no change in the design shape (1421). The manufacturing error of L₁ (1412), however, was deteriorated in comparison with the case of no change in the design shape (1411). On the other hand, in the case where the design shape is changed according to an embodiment of the present invention as illustrated in FIG. 13 Diagram C (1413, 1423), both of the manufacturing errors of L₁ (1413) and L₂ (1423) were decreased in comparison with the case of no change in the design shape.

We claim:

1. A computer implemented method for providing data for minimizing a difference between a plurality of dimensions of a three-dimensional structure formed by a laser radiation and a plurality of design values of a scan path of the three-dimensional structure, the method comprising:
modeling a manufacturing process of the three-dimensional structure and formulating a shrinkage of material used in the manufacturing process, wherein a shrinkage function is formulated in the case where the material shrinks depending on a scan length xᵢ of the scan path of the laser and in which the shrinkage function is represented by an Equation 1; and
performing an optimization calculation for minimizing a difference between the dimensions of the three-dimensional structure after the shrinkage of the material and the design values by using the shrinkage model formulated according to the Equation 1 and computing a scan length x minimizing the difference;
wherein xᵢ of the Equation 1 is the scan length of the scan path and s(l) of the Equation 1 is a shrinkage rate per unit length of the material.

2. The computer implemented method according to claim 1, wherein the shrinkage function is represented by an Equation 2, wherein:
xᵢ is the scan length of the scan path;
s(l, p) is a shrinkage rate per unit length of the material; and
p is a shaping parameter of the manufacturing process.

3. The computer implemented method according to claim 1, wherein the shrinkage function is represented by an Equation 3, wherein:
xᵢ is the scan length of the scan path;
s(l, xⱼ) is a shrinkage rate per unit length of the material; and
xⱼ is a length of a shaped object of a scan path adjacent to the scan path scanned across the scan length xᵢ.

4. The computer implemented method according to claim 1, wherein the shrinkage function is represented by an Equation 4, wherein:
xᵢ is the scan length of the scan path;
s(l, xⱼ, p) is a shrinkage rate per unit length of the material;
xⱼ is a length of a shaped object of a scan path adjacent to the scan path scanned across the scan length xᵢ; and
p is a shaping parameter of the manufacturing process.

5. The computer implemented method according to claim 1, wherein the shrinkage function is represented by an Equation 5, wherein:
xᵢ is the scan length of the scan path;
xⱼₛ is a starting point of a shaped object adjacent to the scan path scanned across the scan length xᵢ;
xⱼₑ is an end point of the shaped object adjacent to the scan path scanned across the scan length xᵢ;
a₁ is a shrinkage rate per unit length of the scan path having a length from the starting point of the scan path scanned across the scan length xᵢ to the point xⱼₛ;
a₂ is a shrinkage rate per unit length of the scan path having a length from the point xⱼₛ to the point xⱼₑ:
a₃ is a shrinkage rate per unit length of the scan path having a length from the point xⱼₑ to the point xᵢ: and
s(l, xⱼ) is a shrinkage rate per unit length of the material and is represented by an Equation 6.

6. The computer implemented method according to claim 1, wherein the shrinkage function is represented by an Equation 7, wherein:
xᵢ is the scan length of the scan path;
xⱼₛ is a starting point of a shaped object adjacent to the scan path scanned across the scan length xᵢ;
xⱼₑ is an end point of the shaped object adjacent to the scan path scanned across the scan length xᵢ;
p is a shaping parameter of the manufacturing process;
a₁ is a shrinkage rate per unit length of the scan path, which fluctuates with the shaping parameter, having a length from the starting point of the scan path scanned across the scan length xᵢ to the point xⱼₛ;
a₂ is a shrinkage rate per unit length of the scan path, which fluctuates with the shaping parameter, having a length from the point xⱼₛ to the point xⱼₑ;
a₃ is a shrinkage rate per unit length of the scan path, which fluctuates with the shaping parameter, having a length from the point xⱼₑ to the point xᵢ; and
s(l, xⱼ, p) is a shrinkage rate per unit length of the material and represented by an Equation 8.

7. The computer implemented method according to claim 1, wherein the shrinkage function is represented by an Equation 9, wherein:
xᵢ is the scan length of the scan path;
xⱼₛ is a starting point of a first shaped object adjacent to the scan path scanned across the scan length xᵢ;
xⱼₑ is an end point of the first shaped object adjacent to the scan path scanned across the scan length xᵢ;
xₖₛ is a starting point of a second shaped object adjacent to the scan path scanned across the scan length xᵢ, and the starting point of the second shaped object exists between the starting point of the first shaped object and the end point of the first shaped object;
xₖₑ is an end point of the second shaped object adjacent to the scan path scanned across the scan length xᵢ, and the end point of the second shaped object exists between the starting point of the first shaped object and the end point of the first shaped object;
a₁ is a shrinkage rate per unit length of the scan path having a length from the starting point of the scan path scanned across the scan length xᵢ to the point xⱼₛ;
a₂ is a shrinkage rate per unit length of the scan path having a length from the point xⱼₛ to the point xₖₛ;
a₃ is a shrinkage rate per unit length of the scan path having a length from the point xₖₛ to the point xₖₑ;
a₄ is a shrinkage rate per unit length of the scan path having a length from the point xₖₑ to the point xⱼₑ;
a₅ is a shrinkage rate per unit length of the scan path having a length from the point xⱼₑ to the point xᵢ; and
s(l, xⱼ, xₖ) is a shrinkage rate per unit length of the material and represented by an Equation 10.

8. The computer implemented method according to claim 1, wherein the shrinkage function is represented by an Equation 11, wherein:
xᵢ is the scan length of the scan path;
xⱼₛ is a starting point of a first shaped object adjacent to the scan path scanned across the scan length xᵢ;
xⱼₑ is an end point of the first shaped object adjacent to the scan path scanned across the scan length xᵢ;
xₖₛ is a starting point of a second shaped object adjacent to the scan path scanned across the scan length xᵢ, and the starting point of the second shaped object exists between the starting point of the first shaped object and the end point of the first shaped object;
p is a shaping parameter of the manufacturing process;
xₖₑ is an end point of the second shaped object adjacent to the scan path scanned across the scan length xᵢ, and the end point of the second shaped object exists between the starting point of the first shaped object and the end point of the first shaped object;
a₁ is a shrinkage rate per unit length of the scan path, which fluctuates with the shaping parameter, having a length from the starting point of the scan path scanned across the scan length xᵢ to the point xⱼₛ;
a₂ is a shrinkage rate per unit length of the scan path, which fluctuates with the shaping parameter, having a length from the point xⱼₛ to the point xₖₛ;
a₃ is a shrinkage rate per unit length of the scan path, which fluctuates with the shaping parameter, having a length from the point xₖₛ to the point xₖₑ;
a₄ is a shrinkage rate per unit length of the scan path, which fluctuates with the shaping parameter, having a length from the point xₖₑ to the point xⱼₑ;
a₅ is a shrinkage rate per unit length of the scan path, which fluctuates with the shaping parameter, having a length from the point xⱼₑ to the point xᵢ; and
s(l, xⱼ, xₖ, p) is a shrinkage rate per unit length of the material and represented by an Equation 12.

9. The computer implemented method according to claim 2, wherein the shaping parameter is at least one selected from the group consisting of a laser power, a laser scan speed, a laser beam radius, a layer thickness, a hatch distance, a total number of layers, and an order of laser scan.

10. The computer implemented method according to claim 1, wherein the step of performing the formulation includes the step of formulating the shrinkage as a shrinkage function with a constraint condition of a length in response to a break of the material caused by the shrinkage of the material when the scan path is irradiated with laser.

11. The computer implemented method according to claim 10, wherein the constraint condition of the length is that the scan length x does not exceed a length at which the break occurs due to the shrinkage of the material.

12. The computer implemented method according to claim 1, wherein the step of performing the formulation includes the step of formulating the shrinkage by dividing the scan path into a plurality of paths in response to a break of the material caused by the shrinkage of the material when the scan path is irradiated with the laser.

13. The computer implemented method according to claim 1, wherein the optimization calculation is performed according to an Equation 13, wherein:
Xᵢ is a design value of the scan path of the three-dimensional structure;
ƒ(xᵢ) is a shrinkage function; and
xᵢ is the scan length of the scan path.

14. The computer implemented method according to claim 13, wherein the optimization calculation is performed according to a constraint condition of the thickness of a surplus growth.

15. The computer implemented method according to claim 14, wherein:
the constraint condition of the thickness of the surplus growth includes the maximum curing depth;
the maximum curing depth Zₘₐₓ is obtained by solving E(0, zₘₐₓ)=Ec in order to obtain the thickness of the surplus growth; and
the character E_{c} is a critical exposure amount.

16. The computer implemented method according to claim 1, wherein the manufacturing process is performed in a stereolithography or a selective laser sintering method.

17. A computer implemented method of providing data for minimizing a difference between a plurality of dimensions of a three-dimensional structure formed by a laser radiation and a plurality of design values of a scan path of the three-dimensional structure, the method comprising:
receiving a three-dimensional model data;
providing a slice data from the three-dimensional model data;
providing a scan path data from the slice data;
modeling a manufacturing process of the three-dimensional structure and formulating a shrinkage of material used in the manufacturing process, wherein a shrinkage function is formulated in the case where the material shrinks depending on a scan length xᵢ of the scan path of the laser and in which the shrinkage function is represented by an Equation 1;
performing an optimization calculation for minimizing a difference between the dimensions of the three-dimensional structure after the shrinkage of the material and the design values by using the shrinkage model formulated according to the Equation 1 and computing a scan length x minimizing the difference; and
outputting the scan path data including a scan length x minimizing the difference;
wherein xᵢ of the Equation 1 is the scan length of the scan path and s(l) of the Equation 1 is a shrinkage rate per unit length of the material.

18. A non-transitory computer program product for providing data for minimizing a difference between a plurality of dimensions of a three-dimensional structure formed by a laser radiation and a plurality of design values of a scan path of the three-dimensional structure, the computer program product comprising a computer readable storage medium having program instructions embodied therewith which, when executed, cause a computer device to perform the steps of a method comprising:
modeling a manufacturing process of the three-dimensional structure and formulating a shrinkage of material used in the manufacturing process, wherein a shrinkage function is formulated in the case where the material shrinks depending on a scan length xᵢ of the scan path of the laser and in which the shrinkage function is represented by an Equation 1; and
performing an optimization calculation for minimizing a difference between the dimensions of the three-dimensional structure after the shrinkage of the material and the design values by using the shrinkage model formulated according to the Equation 1 and computing a scan length x minimizing the difference;
wherein xᵢ of the Equation 1 is the scan length of the scan path and s(l) of the Equation 1 is a shrinkage rate per unit length of the material.

19. The non-transitory computer program product according to claim 18, wherein the method further comprises:
receiving a three-dimensional model data;
providing a slice data from the three-dimensional model data; and
providing a scan path data from the slice data.

20. A three-dimensional structure manufacturing machine which is connected to a computer having a storage medium storing the non-transitory computer program product comprising a computer readable storage medium having program instructions embodied therewith which, when executed, cause a computer device to perform the steps of a method comprising:
modeling a manufacturing process of the three-dimensional structure and formulating a shrinkage of material used in the manufacturing process, wherein a shrinkage function is formulated in the case where the material shrinks depending on a scan length xᵢ of the scan path of the laser and in which the shrinkage function is represented by an Equation 1; and
performing an optimization calculation for minimizing a difference between the dimensions of the three-dimensional structure after the shrinkage of the material and the design values by using the shrinkage model formulated according to the Equation 1 and computing a scan length x minimizing the difference;
wherein xᵢ of the Equation 1 is the scan length of the scan path and s(l) of the Equation 1 is a shrinkage rate per unit length of the material.
